(19) United States
(12) Patent Application Publication
(10) Pub. No.: US 2004/0243443 A1
(43) Pub. Date: Dec. 2, 2004

(54) Healthcare support apparatus, health care support system, health care support method and health care support program

(75) Inventors: Masakazu Asano, Osaka (JP); Yasuo Okuda, Osaka (JP); Hirokazu Genno, Osaka (JP)

Correspondence Address: McDERMOTT, WILL & EMERY, 600 13TH Street, N.W., Washington, DC, 20005-3096, US

(73) Assignee: SANYO ELECTRIC CO., LTD.

(21) Appl. No.: 10/854,218

(22) Filed: May 27, 2004

(30) Foreign Application Priority Data
May 29, 2003 (JP) 2003-152239

(51) Int. Cl. G06F 17/60; G09B 3/00; G09B 19/18

(52) U.S. Cl. 705/2; 434/107

(57) ABSTRACT

A user is regularly asked questions on his/her lifestyle, physical condition, and mental condition. The user regularly inputs his/her own vital data and personal information. A voice input by the user is subject to analysis. Optimum advice is presented which is compatible with the present condition of the user, based on the answers to the questions, vital data, and results of the voice analysis. Extraction of items with problems from the medical questions and items of input data determines which medical questions and items of input data should be asked with attention from next time and the frequency of asking, simultaneously with optimization of an advice presenting algorithm.

### BACKGROUND OF THE INVENTION

1. Field of the Invention

The present invention relates to a health care support apparatus, health care support system, health care support method, and health care support program for supporting the health care.

2. Description of the Background Art

A patient with a lifestyle-related disease such as diabetes needs self health care, such as home-based dietary therapy, kinesitherapy, and improvement of lifestyle in addition to tests and treatments at hospital. However, practice of improving the condition of a disease by such self-care often causes setback along the way, because of the difficulty in maintaining a motivation for a long period.

It is also common that the patient is susceptible to depression which lowers the consciousness for the self-care, and becomes a cause of the setback. For the maintenance of self-care, it is necessary to keep high the patient's motivation for the self-care.

Conventionally, a variety of systems for supporting the health care have been proposed. A health improvement system has been proposed, for example, which calculates a level of vigor, a level of change toward desired behaviors, and a habitual level of the changed behaviors based on data of medical questions, and comprehensively calculates a level of establishment of improvement according to these levels (refer to JP 2000-37354 A, for example).

In addition, a lifestyle improvement support system which informs advice fitted to the actual conditions and stress condition of the user has been proposed (refer to JP2000-311192 A, for example).

Furthermore, a health condition judgment apparatus and a health condition judgment method have been proposed which present comments based on the present and past vital information of a subject (refer to JP 11-206719 A, for example).

A home health care system has also been proposed which provides advice relating to diet and exercise based on the data on health conditions of family members and daily meals (refer to JP 10-74226 A).

The conventional systems and apparatuses, however, provides unbalanced advice when items of input data only have single or few categories. For this reason, they fail to provide optimum advice compatible with the health condition of a user.

In the case of employing multiple data, on the other hand, an enormous number of medical questions and data inputs are required, which results in increased efforts for the user, and accordingly, reduction in the frequency of the system utilization. As a result, the motivation for the self-care is lowered.

### SUMMARY OF THE INVENTION

An object of the present invention is to provide a health care support apparatus, a health care support system, a health care support method, and a health care support program which enable the maintenance and improvement of a motivation for self-care through efficient acquisition of minimum information.

Another object of the present invention is to provide a health care support apparatus, a health care support system, a health care support method, and a health care support program which enable the maintenance and improvement of a motivation for self-care through efficient and effective presentation of optimum advice which is compatible with the condition of a user.

A health care support apparatus according to one aspect of the present invention comprises: an acquisition unit that acquires information relating to a health condition of a user; and a changing unit that changes one or more items of information to be subsequently acquired by the acquisition unit and a frequency of acquisition, based on the information acquired by the acquisition unit.

In the health care support apparatus, the information relating to the health condition of the user is acquired by the acquisition unit, and one or more items of information to be subsequently acquired based on the acquired information and the frequency of acquisition are changed by the changing unit.

This optimizes the information relating to the health condition to be acquired, and the efficient acquisition of the minimum information enables efficient and effective promotion of the self-care. As a result, the motivation for the self-care can be maintained and improved.

The changing unit may compare the information acquired by the acquisition unit with a predetermined criterion value, and change one or more items of information to be subsequently acquired by the acquisition unit and a frequency of acquisition, based on a result of the comparison.

This changes automatically and appropriately one or more items of information to be subsequently acquired and the frequency of acquisition, based on the result of comparison between the acquired information and criterion value.

The changing unit may store beforehand a relationship between a value of information relating to a health condition of the user and a frequency of acquisition, and change one or more items of information to be subsequently acquired by the acquisition unit and a frequency of acquisition, based on the information acquired by the acquisition unit and the relationship.

This changes automatically and appropriately one or more items to be subsequently acquired and the frequency of acquisition, based on the acquired information and the relationship stored beforehand.

The changing unit may determine whether or not a contents of the information acquired by the acquisition unit is critical, and change one or more items of information to be subsequently acquired by the acquisition unit and a frequency of acquisition, based on a result of the determination.

This changes automatically and appropriately one or more items of information to be subsequently acquired and the frequency of acquisition, based on the result of determination whether or not the contents of acquired information is critical.

The health care support apparatus may further comprise: a target formation unit that forms a behavioral or a health-related target of the user; and an evaluation unit that evaluates a degree of achievement of the target formed by the target formation unit based on the information acquired by the acquisition unit.

In this case, the behavioral or health-related target of the user is formed, and the degree of achievement of the formed target is evaluated based on the acquired information. This enables the user to recognize his/her own degree of achievement of the behavioral or health-related target, thereby improving the motivation for a target afterward.

A health care support apparatus according to another aspect of the present invention comprises: an acquisition unit that acquires information relating to a health condition of a user; a determination unit that determines whether the information acquired by the acquisition unit is good or bad; an extraction unit that extracts an item to be careful about the health condition of the user, based on a result of the determination of the determination unit; and a presentation unit that presents advice relating to the item extracted by the extraction unit based on the information acquired by the acquisition unit.

In the health care support apparatus, the information relating to the health condition of the user is acquired by the acquisition unit, and a determination is made whether or not the acquired information is good or bad. In addition, the item to be careful of the health condition of the user is extracted by the extraction unit based on the result of determination, and the advice relating to the extracted item based on the acquired information is presented by the presentation unit.

This efficiently presents effective advice which is compatible with the health condition of the user. Accordingly, the self-care is efficiently and effectively promoted. As a result, the motivation for the self-care can be maintained and improved.

The acquisition unit may acquire a plurality of items of information from a physiological amount of the user, user's own information, information relating to a voice of the user, information relating to a physical condition of the user, information relating to a mental condition of the user, and information relating to a lifestyle of the user, and the presentation unit may present advice based on a combination of the plurality of items of information acquired by the acquisition unit.

In this case, the plurality of items of the physiological amount of the user, user's own information, information relating to the voice of the user, information relating to the physical condition of the user, information relating to the mental condition of the user, and information relating to the lifestyle of the user are acquired, and the advice is presented by the presentation unit based on the combination of the plurality of items of the information acquired. This presents comprehensive advice based on the plurality of items of information.

The presentation unit may extract items of information relating to one another from the plurality of items of information acquired by the acquisition unit, and present advice based on a combination of the extracted items of information.

In this case, the advice is presented based on the combination of the plurality of items of information relating to one another. This presents appropriate and comprehensive advice based on the plurality of items of information relating to one another.

The presentation unit may determine whether or not each item of the plurality of information acquired by the acquisition unit is critical, and extract a critical item of information and another critical item of information relating to that critical item of information, and present advice based on a combination of the extracted items of information.

In this case, the advice is presented based on the combination of the critical item of information and the critical item of information relating to that critical item of information. This presents more appropriate and comprehensive advice.

The health care support apparatus may further comprise a verification unit that verifies a user's behavior and an effect which relate to the health care, based on the information acquired by the acquisition unit, the presentation unit presenting advice including a behavior to be conducted afterward based on a causal relationship between the behavior and the effect verified by the verification unit.

In this case, the behavior and effect of the user relating to the health care are verified based on the acquired information, and the advice including the behavior to be conducted afterward is presented based on the causal relationship between the verified behavior and effect. This enables the user to recognize the effect which is a result of the behavior relating to his/her own health care, thereby improving the motivation for the behavior to be conducted afterward.

The health care support apparatus may further comprise: a selection unit that selects an item to be improved relating to the behavior and health of the user based on the information acquired by the acquisition unit; and a determination unit that determines a behavior for improving the item selected by the selection unit, the presentation unit presenting advice including the behavior determined by the determination unit.

In this case, the item to be improved relating to the behavior and health of the user is extracted based on the acquired information, and the behavior for the improvement of the extracted item is determined, and the advice including the determined behavior is presented. This enables the user to fully recognize the item to be improved relating to his/her own behavior and health, while being conscious of the behavior for the improvement. Accordingly, more effective self-care can be realized.

The health care support apparatus may further comprise a changing unit that changes one or more items of information to be subsequently acquired by the acquisition unit and a frequency of acquisition, based on the information acquired by the acquisition unit.

In this case, the information relating to the health condition of the user is acquired, and one or more items of information to be subsequently acquired and the frequency of acquisition are changed based on the acquired information.

This optimizes the information relating to the health condition to be acquired, and the efficient acquisition of the minimum information enables efficient and effective promotion of the self-care.

The acquisition unit may include a questioning unit that asks questions to the user while inputting answers to the questions, the information relating to the health condition including the answers input by the questioning unit.

In this case, the questions are asked to the user, and simultaneously the answers to the questions are input, and the input answers are acquired as the information relating to the health condition. This enables efficient acquisition of the appropriate information relating to the health condition of the user.

The questioning unit may ask one or a plurality of questions from questions relating to physical condition, questions relating to mental condition, and questions relating to lifestyle, as a question to the user.

In this case, as the question to the user, one or a plurality of questions are asked to the user from the questions relating to the physical condition, mental condition, and lifestyle. This enables efficient acquisition of the appropriate information relating to the health condition of the user.

The acquisition unit may include an input unit that inputs one or a plurality of items from information relating to a physiological amount of the user, user's own information, and information relating to a voice of the user, the information relating to the health condition being input by the input unit.

In this case, one or a plurality of items from the information relating to the physiological amount of the user, user's own information, and the information relating to the voice of the user are input, the input information being acquired as the information relating to the health condition. This enables efficient acquisition of the appropriate information relating to the health condition of the user.

The health care support apparatus may further comprise: a target formation unit that forms a behavioral or a health-related target of the user; and an evaluation unit that evaluates a degree of achievement of the target formed by the target formation unit based on the information acquired by the acquisition unit.

In this case, the behavioral or health-related target of the user is formed, and the degree of achievement of the formed target is evaluated based on the acquired information. This enables the user to recognize the degree of achievement of his/her own behavioral or health related target, thereby improving the motivation for a target afterward.

The health care support apparatus may further comprise a display that displays a history of the information acquired by the acquisition unit or an item of information yet to be acquired by the acquisition unit.

In this case, with the display of history of the acquired information and the item of information yet to be acquired, the user can readily recognize the item of information to be input. This enables input of sufficient information with minimized effort.

A health care support system according to still another aspect of the invention comprises: a user terminal for use by a user; and a host computer, the host computer comprising: an acquisition unit that acquires information relating to a health condition of the user from the user terminal; and a changing unit that changes one or more items of information to be subsequently acquired by the acquisition unit and a frequency of acquisition, based on the information acquired by the acquisition unit.

In the health care support system, the information relating to the health condition of the user is acquired by the acquisition unit, and one or more items of information to be subsequently acquired and the frequency of acquisition are changed by the changing unit based on the acquired information.

This enables optimization of the information relating to the health condition to be acquired, and the efficient acquisition of minimum information can efficiently and effectively promote the self-care. As a result, the motivation for the self-care can be maintained and improved.

A health care support system according to still anther aspect of the present invention comprises: a user terminal for use by a user; and a host computer, the host computer comprising: an acquisition unit that acquires information relating to a health condition of the user from the user terminal; a determination unit that determines whether the information acquired by the acquisition unit is good or bad; an extraction unit that extracts an item to be careful about the health condition of the user based on a result of the determination of the determination unit; and a presentation unit that presents on the user terminal advice relating to the item extracted by the extraction unit based on the information acquired by the acquisition unit.

In the health care support system, the information relating to the health condition of the user is acquired by the acquisition unit, and a determination is made whether the acquired information is good or bad. In addition, the item to be careful of the health condition of the user is extracted by the extraction unit based on the result of determination, and the advice relating to the extracted item based on the acquired information is presented.

This enables efficient presentation of effective advice which is compatible with the health condition of the user. This can promote the self-care efficiently and effectively. As a result, the motivation for the self-care can be maintained and improved.

A health care support method according to still another aspect of the present invention comprises the steps of: acquiring information relating to a health condition of a user; and changing one or more items of information to be subsequently acquired and a frequency of acquisition, based on the acquired information.

In the health care support method, the information relating to the health condition of the user is acquired, and one or more items of information to be subsequently acquired and the frequency of acquisition are changed based on the acquired information.

This enables optimization of the information relating to the health condition to be acquired, and the efficient acquisition of minimum information enables efficient and effective promotion of the self-care. As a result, the motivation for the self-care can be maintained and improved.

A health care support method according to still another aspect of the present invention comprises the steps of: acquiring information relating to a health condition of a user; determining whether the acquired information is good or bad; extracting an item to be careful about the condition of the user based on a result of the determination; and presenting advice relating to the extracted item based on the acquired information.

In the health care support method, the information relating to the health condition of the user is acquired, and a determination is made whether the acquired information is good or bad. In addition, the item to be careful about the health condition of the user is extracted based on the result of determination, and the advice relating to the extracted item is presented based on the acquired information.

This efficiently presents effective advice which is compatible with the health condition of the user. Accordingly, the self-care can be promoted efficiently and effectively. As a result, the motivation for the self-care can be maintained and improved.

A health care support program according to still another aspect of the present invention is a computer-readable health care support program which enables a computer to implement the processes of: acquiring information relating to a health condition of a user; and changing one or more items of information to be subsequently acquired and a frequency of acquisition, based on the acquired information.

In the health care support program, the information relating to the health condition of the user is acquired, and one or more items of information to be subsequently acquired and the frequency of acquisition are changed based on the acquired information.

This optimizes the information relating to the health condition to be acquired, and the efficient acquisition of minimum information enables efficient and effective promotion of the self-care. As a result, the motivation for the self-care can be maintained and improved.

A health care support program according to still another aspect of the present invention is a computer-readable health care support program which enables a computer to implement the processes of: acquiring information relating to a health condition of a user; determining whether the acquired information is good or bad; extracting an item to be careful about the health condition of the user based on the acquired information; and presenting advice relating to the extracted item based on the acquired information.

In the health care support program, the information relating to the health condition of the user is acquired, and a determination is made whether the acquired information is good or bad. In addition, the item to be careful about the health condition of the user is extracted based on the result of determination, and the advice relating to the extracted item based on the acquired information item is presented.

This efficiently presents effective advice which is compatible with the health condition of the user. Accordingly, the self-care can be promoted efficiently and effectively. As a result, the motivation for the self-care can be maintained and improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the summary of a health care support system according to one embodiment of the present invention;

FIG. 2 is a block diagram showing the structure of the health care system according to the embodiment of the present invention;

FIG. 3 is a diagram showing the database which is constructed in the internal storage device in the server of FIG. 2;

FIG. 4 is a flowchart showing the general operation of the health care support system of FIG. 1;

FIG. 5 is a flowchart showing a process of beginning the system by the operational unit in the server;

FIG. 6 is a flowchart showing a basic process by the operational unit in the server;

FIG. 7 is a flowchart showing a process of asking questions by the operational unit in the server;

FIG. 8 is a flowchart showing a process of voice analysis by the operational unit in the server;

FIG. 9 is a flowchart showing a process of determination of a user condition by the operational unit in the server;

FIG. 10 is a flowchart showing a process of presenting advice by the operational unit in the server;

FIG. 11 is a flowchart showing a process of effect verification by the operational unit in the server;

FIG. 12 is a flowchart showing a process of presenting advice by the operational unit in the server;

FIG. 13 shows one example of personal information;

FIG. 14 shows one example of vital data;

FIG. 15 shows one example of lifestyle questions;

FIG. 16 shows one example of mental questions;

FIG. 17 shows one example of physical questions;

FIG. 18 shows one example of recommendations for user's work;

FIG. 19(a) shows one example of behavioral targets;

FIG. 19(b) shows one example of settings of behavioral target values;

FIG. 20 shows one example of a list of risks;

FIG. 21 shows one example of an advice table;

FIG. 22 shows one example of an advice table;

FIG. 23 shows one example of an advice table;

FIG. 24 shows one example of advice;

FIG. 25 shows one example of a behavioral target achievement checklist;

FIG. 26 shows one example of effect verification questions;

FIG. 27 shows one example of a list of effects.

FIG. 28 is a flowchart showing a process of changing the frequency of measuring the vital data by the operational unit in the server;

FIG. 29(a) shows one example of a measurement frequency setting table for respective measured values of the vital data;

FIG. 29(b) shows a graph corresponding to the measurement frequency setting table of FIG. 29(a);

FIG. 30(a) shows another example of the measurement frequency setting table for respective measured values of the vital data;

FIG. 30(b) shows a graph corresponding to the measurement frequency setting table of FIG. 30(a);

FIG. 31 is a flowchart showing a process of changing the frequency of asking a question by the operational unit in the server;

FIG. 32 shows one example of a related item table on lifestyle, physical condition, and mental condition;

FIG. 33 shows one example of the result of determination of a risk for each item and the result of extraction of critical related items;

FIG. 34 is a flowchart showing a process of comprehensive determination of a condition by the operational unit in the server.

### DESCRIPTION OF THE PREFERRED EMBODIMENTS

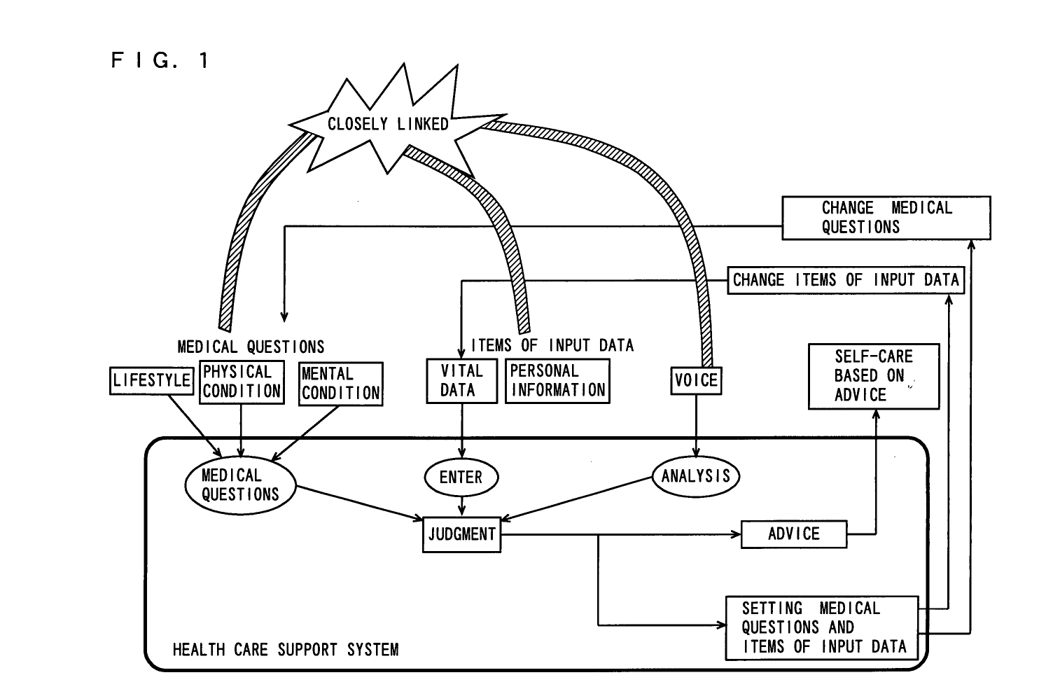

FIG. 1 is a schematic diagram showing the summary of a health care support system according to one embodiment of the present invention.

In the health care support system according to the embodiment, a user is regularly asked medical questions about his/her condition. The user answers his/her present condition in reply to the questions. The questions here include questions relating to the lifestyle (diet, exercise, medication usage, drinking, smoking, relaxation, and the like), physical condition (health condition, subjective symptoms, and the like), and mental condition (psychological condition, i.e., feelings, stress, vigor, and the like).

The questions are mainly asked by output of a voice from a user terminal or presentation of a list of questions, and answered by input of a voice from the user terminal or filling the list of questions. The input voice is converted to data by voice recognition.

Also, the user regularly inputs his/her vital data or personal information (user basic data or user characteristic data). The vital data here denotes data (physiological amount data) relating to physiological amounts which can be objectively measured, such as blood pressure, blood glucose level, body weight, waist level, cholesterol level, and the like. The vital data is automatically input to the user terminal from measurement equipment or input to the user terminal by user's key operation or voice. For example, when the user steps on the scale, the data measured by the scale is automatically transmitted to the user terminal via wireless communication. The personal information denotes his/her own information, such as sex, age, weight, date of birth, case history, family history, present usage of medication, and the like.

Further, the voice input by the user is subject to analysis. Note that for analysis, a voice input to the user terminal upon inputting the answers to the questions or inputting the vital data may be used. Alternatively, a question for voice analysis may be provided so that the user speaks for voice analysis in reply to the question. Based on the vocal tone (pitch), intonation, hoarseness, and the like revealed from the voice analysis, it is possible to estimate the mental condition, feelings, health condition, stress condition and the like at that moment.

Each data acquired by the input of an answer to a question, vital data and personal information along with the voice analysis is an input parameter for a determination algorithm. The determination algorithm selects optimum advice compatible with the present condition of the user, using the input answers to the questions, vital data, and personal information along with voice analysis.

The user inputs basic information when he/she starts utilizing the health care support system. The basic information denotes a lifestyle, physical condition, mental condition, vital data and personal information. The health care support system calculates a risk factor of the development or deterioration of a lifestyle-related disease based on the basic information, and outputs a primary advice. Specifically, the system presents extraction of each item of input data and a general approach, based on an algorithm for determining the vital data according to the personal information such as sex, age, height, and case history; an algorithm for evaluating a mental condition; and an algorithm for determining a lifestyle.

In determination of the blood pressure of the elderly, for example, the criterion value for the maximum blood pressure is set to a value with the addition of 20 to the usual criterion value, which is different from that set for the young. Further, advice for the elderly is varied from that for the young. As for the questions on lifestyle, criteria values are varied depending on the case history of diabetes, high blood pressure, or hyperlipemia.

Of the initial questions and the items of input data, those with problems are extracted to determine which questions and items of input data should be asked with attention from next time, and how frequently they should be asked. For those without smoking habits, for example, the frequency of asking questions on smoking is significantly reduced, whereas for those who have smoking habits and feel the need for smoking, questions on smoking are increased in number or variety.

Further, questions for detecting a change in user's behaviors or awareness on the health care are provided for the detection of advice which may contribute to his/her behavioral change, so as to optimize an advice presenting algorithm.

This health care support system enables presentation of questions and advice appropriate to the condition of the user.

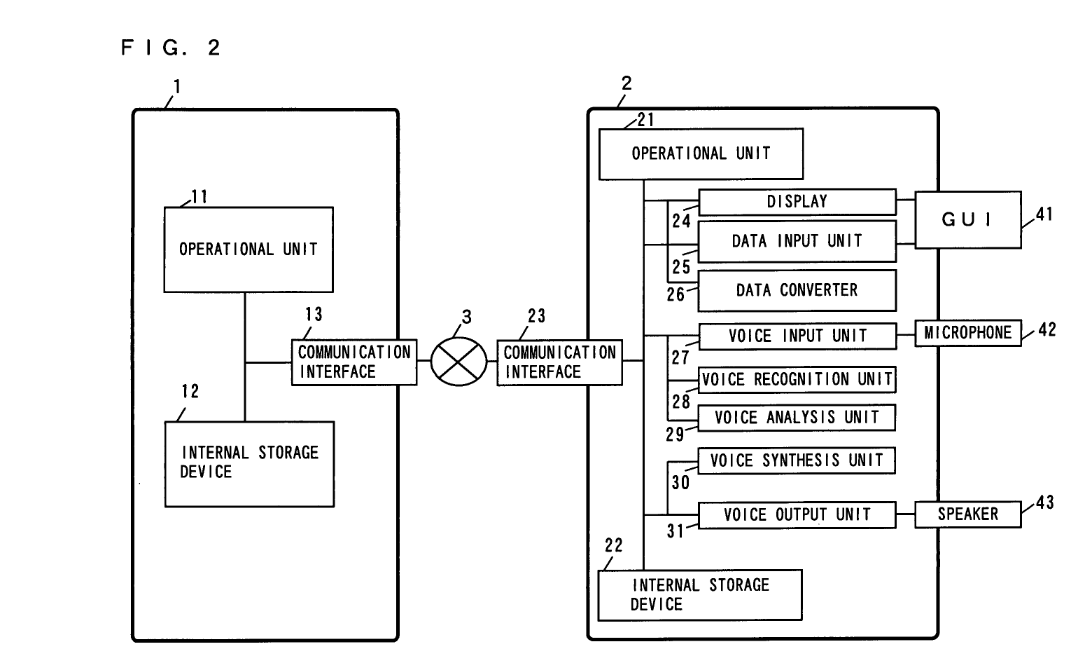

FIG. 2 is a block diagram showing the structure of the health care system according to the embodiment of the present invention.

The health care system of FIG. 2 includes a server 1 and a user terminal 2. The server 1 is located in a service center, for example. The user terminal 2 is for example a personal computer, and located at user's home.

The server 1 includes an operational unit 11, an internal storage device 12, and a communication interface 13. The operational unit 11 is composed of a CPU (Central Processing Unit), a semiconductor memory, and the like. The internal storage device 12 is, for example, a hard disc or the like. The operational unit 11 and internal storage device 12 are connected to a network 3 via the communication interface 13. The network 3 is composed of the Internet, a public network, or the like.

The user terminal 2 includes an operational unit 21, an internal storage device 22, and a communication interface 23. The user terminal 2 further includes a display 24, a data input unit 25, a data converter 26, a voice input unit 27, a voice recognition unit 28, a voice analysis unit 29, a voice synthesis unit 30, a voice output unit 31, a GUI (Graphical User Interface) 41, a microphone 42, and a speaker 43.

The operational unit 21 is composed of a CPU, a semiconductor memory, and the like. The internal storage device 22 is a hard disc, for example. The operational unit 21 and internal storage device 22 are connected to the network 3 via a communication interface 23.

The operational unit 11 in the server 1 determines a condition of the user (health condition, feelings, motivation, and the like) based on the selection of questions, answers to the questions, vital data, and results of voice analysis; sets contents of advice; sets vital target values; sets lifestyle target values; evaluates the results of progress and improvements in the self-care; changes the target values and respective set criteria.

The internal storage device 12 stores criteria and procedures for the selection of questions, determination of a condition of the user, selection of advice, and setting target values; histories of user basic data (age, sex, and the like), user's characteristic data (personality, past illness, and the like), answers to questions, vital data, and results of voice analysis; target values; and contents of advice.

The operational unit 21 in the user terminal 2 asks questions, supports vital data input, records and transmits answers to the questions, vital data, and results of voice analysis, and also executes advice.

The internal storage device 22 stores histories of the user data, questions, answers to the questions, vital data, and results of voice analysis, target values, and contents of advice.

The GUI 41 is used for the display of target values, state of progress, and the like, and for input of the vital data. The microphone 42 is used for input of answers to the questions, vital data, and the like. The speaker 43 is used for output of voices for advice, questions, and a relaxation program.

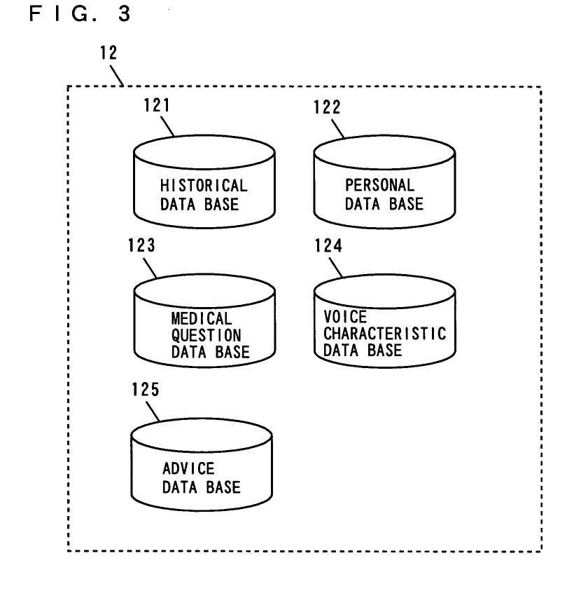

FIG. 3 is a diagram showing the database which is constructed in the internal storage device 12 in the server 1 of FIG. 1.

In the internal storage device 12, a historical database 121, a personal database 122, a medical question database 123, a voice characteristic database 124, and an advice database 125 are constructed.

In the historical database 121, various types of histories are stored, such as histories of questions, voice analysis, and determination results on user condition. In the personal database 122, a personal profile list, recommendations for user's work, behavioral targets, a list of risks, and the like described later are stored. In the medical question database 123, each of lifestyle questions, physical questions, and mental questions are stored. In the voice characteristic database 123, a characteristic amount of the user's usual voice is stored. In the advice database 125, advice items, advice tables TB1, TB2, TB3 and the like described later are stored.

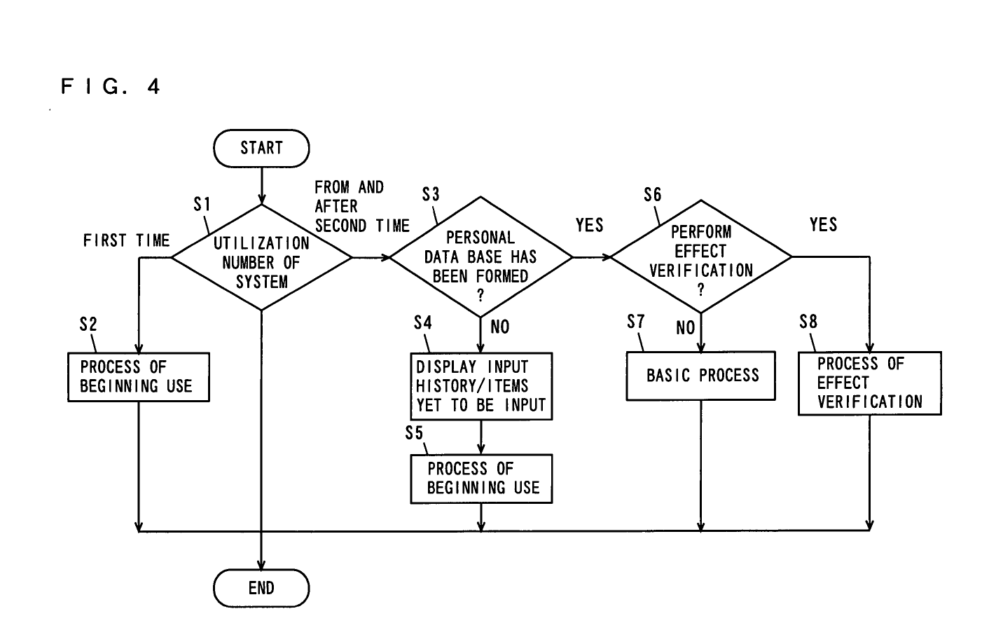

FIG. 4 is a flowchart showing the general operation of the health care support system of FIG. 1.

Initially, at the beginning of the health care support system use, the user notifies the server 1 from the user terminal 2 that he/she will start the use. This causes the operational unit 11 in the server 1 to determine the number of times that the user has utilized the health care support system (Step Si). Where the user utilizes the health care support system for the first time, the operational unit 11 performs a process of beginning the use mentioned later (Step S2).

When it is not the first time for the user to utilize the health care support system, the operational unit 11 determines whether the user's personal database 122 has already been formed (Step S3). The operational unit 11 determines that the personal database 122 has not been formed if the user did not input some items at the time of his/her first utilization.

Where the personal database 122 has not been formed, the operational unit 11 allows the user terminal 2 to display a history of inputs and items yet to be input (Step S4). After that, the operational unit 11 performs the process of beginning the use (Step S5).

When the personal database 122 has been formed, the operational unit 11 inquires the user via the user terminal 2 if he/she performs effect verification (Step S6). The user transmits the answer from the user terminal 2 to the server 1. When receiving an answer that the user will not perform effect verification, the operational unit 11 performs a basic process mentioned later (Step S7).

When receiving an answer that the user will perform effect verification, the operational unit 11 performs a process of effect verification mentioned later (Step S8).

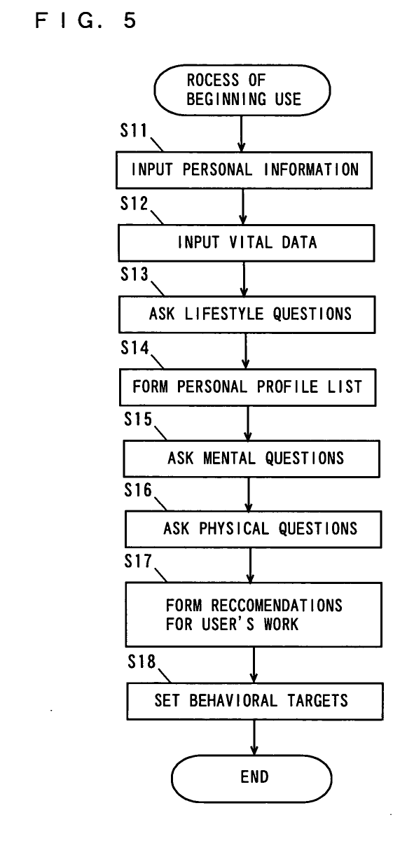

FIG. 5 is a flowchart showing the process of beginning the system by the operational unit 11 in the server 1.

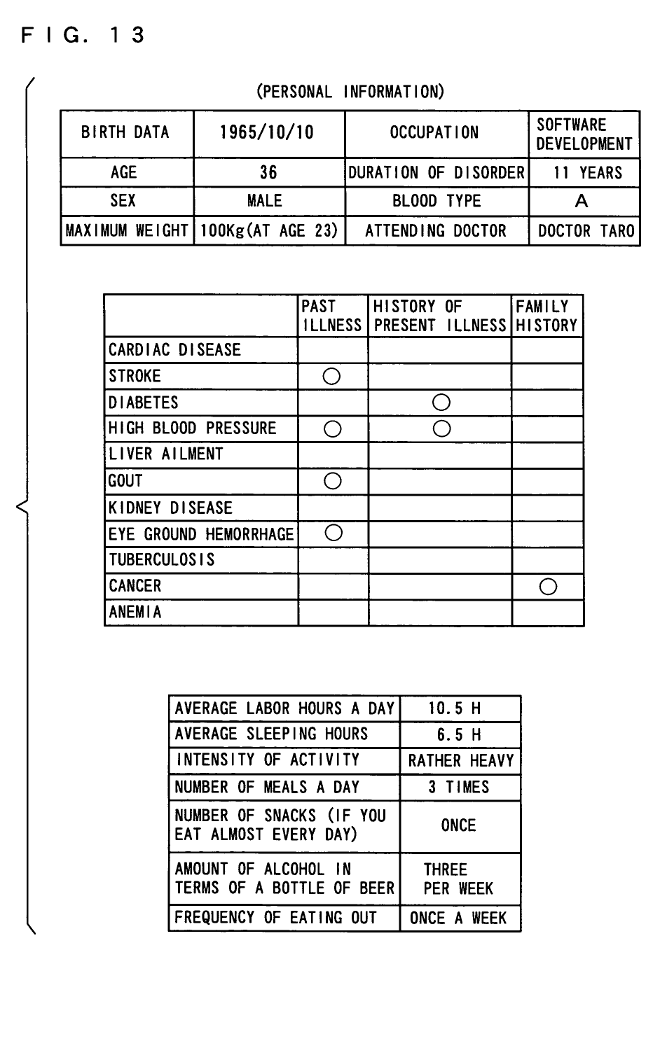

The operational unit 11 in the server 1 instructs the user to input personal information via the user terminal 2 (Step S11). The personal information here denotes the user's personal information, such as sex, date of birth, height, case history, and family history. FIG. 13 shows one example of the personal information. The user inputs his/her personal information via the user terminal 2. The input personal information is transmitted to the server 1.

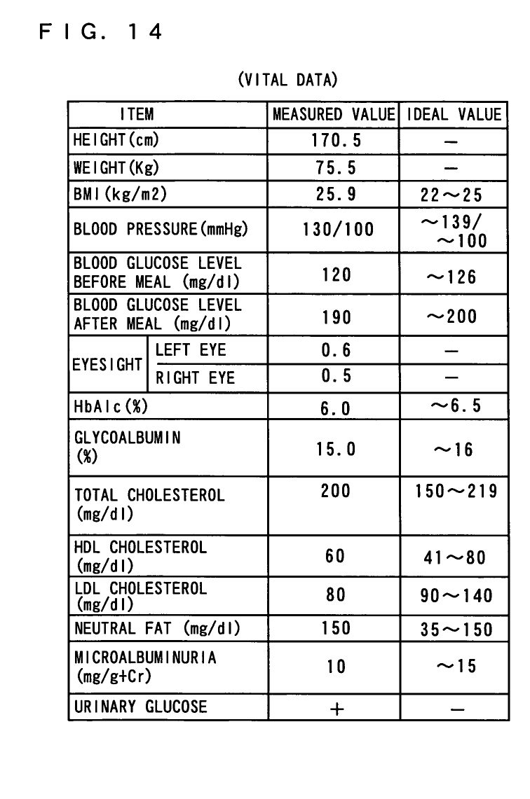

The operational unit 11 subsequently instructs the user to input vital data (hospital examination data) via the user terminal 2 (Step S12). The vital data here denotes measured values of the body, such as body weight, blood pressure, blood glucose level, BMI (weight (kg)/height (m)²), and the number of steps. FIG. 14 shows one example of the vital data. The user inputs his/her vital data via the user terminal 2. The input vital data is transmitted to the server 1.

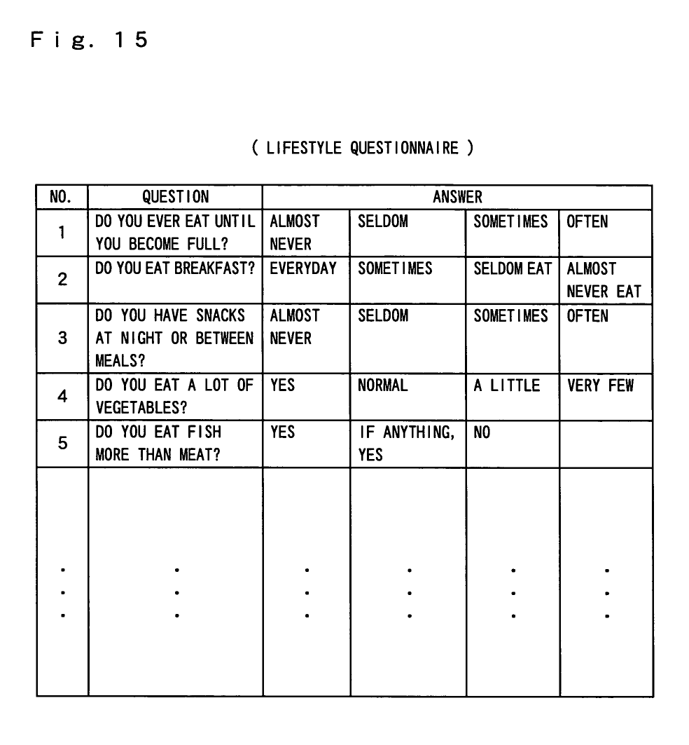

The operational unit 11 subsequently asks lifestyle questions via the user terminal 2 (Step S13). The lifestyle questions here means medical questions on diet, exercise, medication usage, drinking, smoking and relaxation. FIG. 15 shows one example of lifestyle questions. The operational unit 11 displays or outputs as a voice the lifestyle questions on the user terminal 2. The user inputs the answers to the lifestyle questions on lifestyle via the user terminal 2. The input answers to the questions are transmitted to the server 1.

The operational unit 11 then forms a personal profile list based on the received personal information, vital data, and answers to the lifestyle questions (Step S14). The personal information of FIG. 13, vital data of FIG. 14, and answers to the lifestyle questions of FIG. 15 for example are recorded in the personal database 122 as a personal profile list.

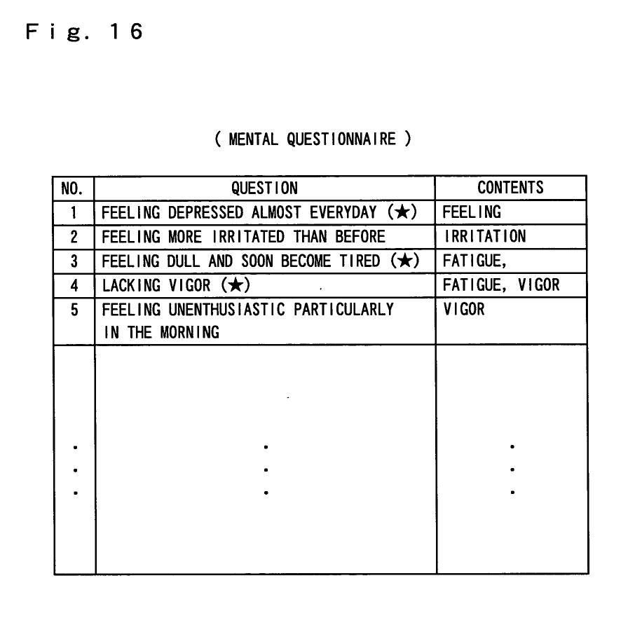

The operational unit 11 subsequently asks the user mental questions via the user terminal 2 (Step S15). The mental questions here denote medical questions relating to psychological condition including a feeling checking, stress checking, vigor checking, and depression checking. FIG. 16 shows one example of the mental questions. The operational unit 11 displays or outputs as a voice the mental questions on the user terminal 2. The user inputs answers to the mental questions via the user terminal 2. The input answers to the mental questions are transmitted to the server 1.

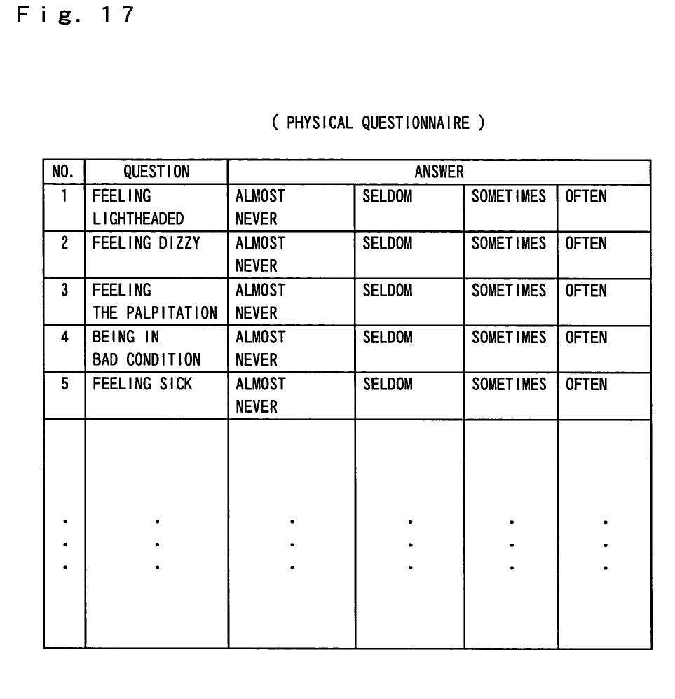

The operational unit 11 subsequently asks the user physical questions via the user terminal 2 (Step S16). The physical questions here denote medical questions relating to the physical condition, such as health condition and subjective symptoms. FIG. 17 shows one example of the physical questions. The operational unit 11 displays or outputs as a voice the physical questions on the user terminal 2. The user inputs answers to the physical questions via the user terminal 2. The input answers to the physical questions are transmitted to the server 1.

The operational unit 11 further forms the recommendations for user's work based on the personal profile list, and answers to the mental questions and the physical questions (Step S17). Note that the recommendations for user's work include items of input data and their frequencies (performance timings) along with questions and their frequencies (performance timings).

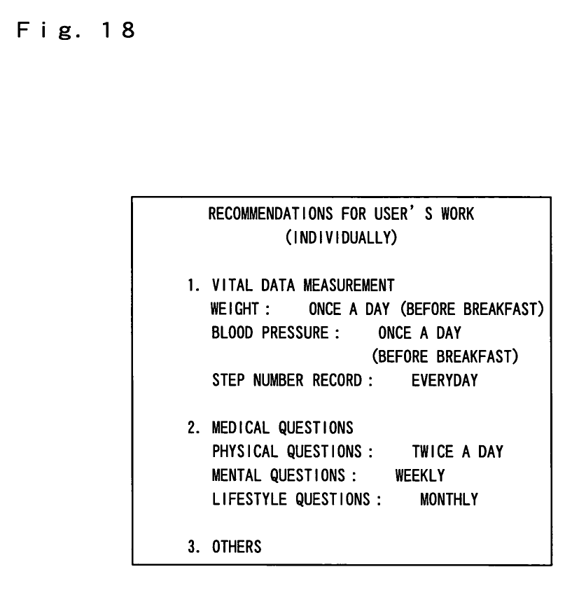

FIG. 18 shows one example of the recommendations for user's work. The operational unit 11 displays the recommendations for user's work on the user terminal 2. The recommendations for user's work are recorded in the personal database 122.

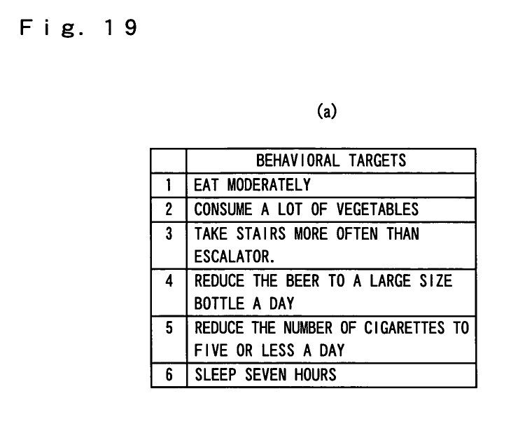

Finally, the operational unit 11 instructs the user to set behavioral targets via the user terminal 2 (Step S18). In this case, the operational unit 11 forms recommended behavioral targets based on the personal profile list and answers to mental and physical questions for display on the user terminal 2. The behavioral targets here denote items to be improved by the user in terms of health. The behavioral targets include target values for various vital data. Examples of the target values for the vital data include target values for the body weight, blood pressure level, blood glucose level, and number of steps. The user sets such behavioral targets for him/herself based on the recommended behavioral targets and target values. The behavioral targets thus set are transmitted to the server 1. FIG. 19(a) shows one example of the behavioral targets, and FIG. 19(b) shows one example of settings of the behavioral target values. The behavioral targets are recorded in the personal database 122.

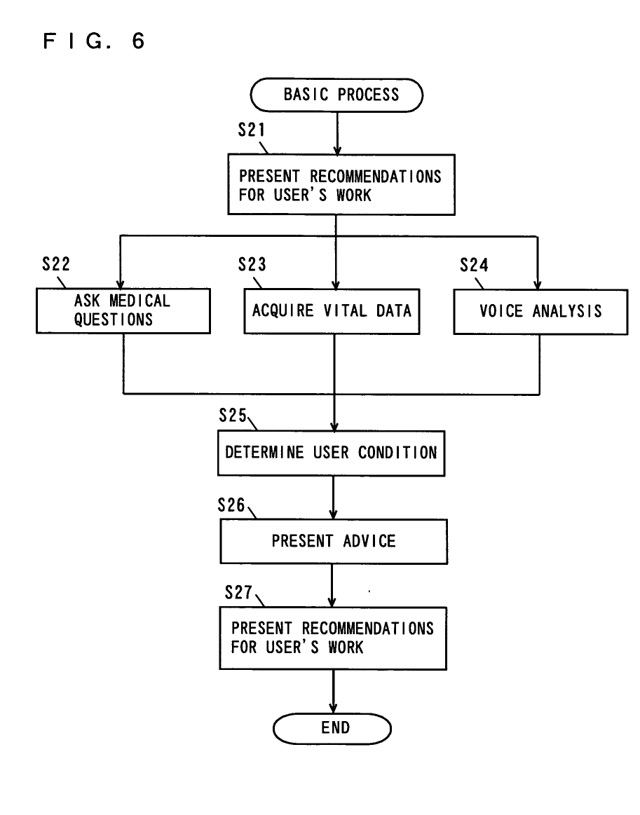

FIG. 6 is a flowchart showing the basic process by the operational unit 11 in the server 1.

The operational unit in the server 1 initially presents to the user the recommendations for user's work recorded in the personal database 122 via the user terminal 2 (Step S21).

The operational unit 11 in the server 1 subsequently instructs the user terminal 2 to ask questions (Step S22), acquire vital data (Step S23), and perform voice analysis (Step S24). For asking questions, the operational unit 11 selects appropriate questions from the lifestyle questions, mental questions, and physical questions based on the behavioral targets recorded in the personal database 122, and displays or outputs as a voice the selected questions on the user terminal 2. For input of the vital data, the operational unit 11 selects appropriate items of input data based on the behavioral targets recorded in the personal database 122, and displays or outputs as a voice the selected items of input data on the user terminal 2.

The asking of questions and voice analysis will later be described in detail. For the acquisition of vital data, the operational unit 21 in the user terminal 21 supports the input of vital data by the user through the use of GUI 41, display 24, and data input unit 25. The operational unit 21 stores the answers to the questions, vital data and results of the voice analysis in the internal storage device 22 while transmitting them to the server 1. The operational unit 11 in the server 1 records the answers to the questions, vital data and results of the voice analysis received from the user terminal 2 as a question history, a vital history, and a voice analysis history, respectively, into the historical database 121. Note that the sequence of asking questions, acquiring vital data, and voice analysis is not restricted.

The operational unit 11 determines a user condition based on the contents of the personal database 122, and answers to the questions, vital data and results of voice analysis recorded in the historical database 121 (Step S25). The user condition here includes a health condition, feelings, motivation, and the like. The determination of the user condition will later be described in detail.

The operational unit 11 subsequently presents advice to the user via the user terminal 2 based on the result of determination of the user condition (Step S26). The presentation of advice will later be described in detail.

Then, the operational unit 11 changes the recommendations for user's work recorded in the personal database 122 based on the result of determination of the user condition, to present to the user the changed recommendations for user's work via the user terminal 2 (Step S27). In this case, the operational unit 11 changes the items of input data and their frequencies (performance timings) along with the questions and their frequencies (performance timings). In the example of the recommendations for user's work shown in FIG. 18, measurement is made more frequently for any increase in the blood pressure.

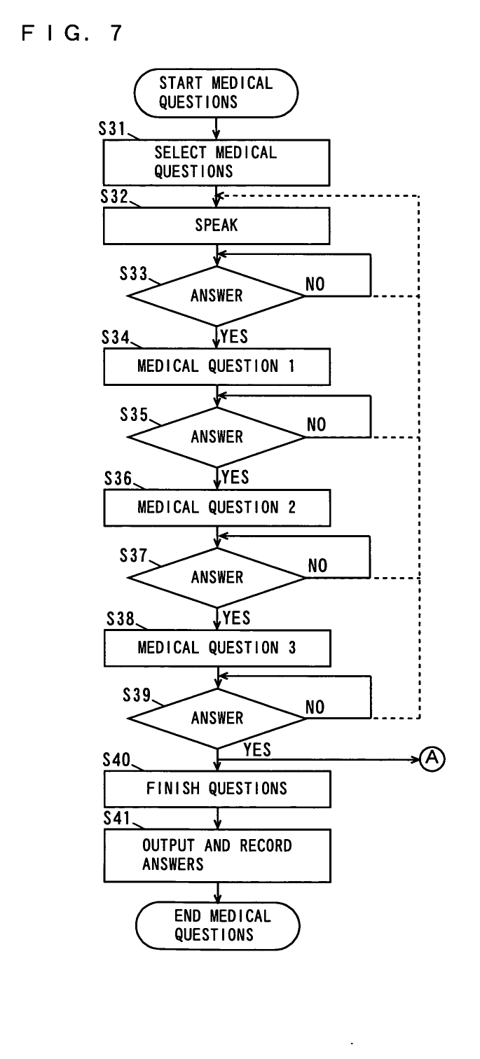

FIG. 7 is a flowchart showing a process of asking medical medical questions by the operational unit 11 in the server 1.

The operational unit 11 in the server 1 initially selects questions from the data stored in the medical question database 123 (Step S31). In this case, the operational unit 11 selects, for example, three questions based on behavioral targets.

Then, the operational unit 11 instructs the user terminal 2 to speak (Step S32). This causes the operational unit 21 in the user terminal 2 to output, for example, “hello” from the speaker 43 to the user. The user inputs a reply using the microphone 42 in the user terminal 2. The input reply from the user is transmitted to the server 1.

The operational unit 11 in the server 1 determines whether there has been a reply from the user terminal 2 (Step S13). When receiving the reply from the user terminal 2, the operational unit 11 transmits a first question to the user terminal 2 (Step S34). This causes the operational unit 21 in the user terminal 2 to output the first question from the speaker 43 to the user. The user inputs an answer with the microphone 42 in the user terminal 2. The input answer from the user is transmitted to the server 1.

The questions are answered with yes or no. The question asks, for example, “Are you in good condition today?”

The operational unit 11 in the server 1 determines whether there has been an answer from the user terminal 2 (Step S35). When receiving the answer from the user terminal 2, the operational unit 11 transmits a second question to the user terminal 2 (Step S36). This causes the operational unit 21 in the user terminal 2 to output the second question from the speaker 43 to the user. The user inputs an answer with the microphone 42 in the user terminal 2. The input reply from the user is transmitted to the server 1.

The operational unit 11 in the server 1 determines whether there has been an answer from the user terminal 2 (Step S37). When receiving the answer from the user terminal 2, the operational unit 11 transmits a third question to the user terminal 2 (Step S38). This causes the operational unit 21 in the user terminal 2 to output the third question from the speaker 43 to the user. The user inputs an answer with the microphone 42 in the user terminal 2. The input answer from the user is transmitted to the server 1.

The operational unit 11 in the server 1 determines whether there has been an answer from the user terminal 2 (Step S39). In receiving the answer from the user terminal 2, the operational unit 11 transmits notice of finishing the questions to the user terminal 2 (Step S40). This causes the operational unit 21 in the user terminal 2 to output, for example, “Thank you” from the speaker 43 to the user.

Finally, the operational unit 11 in the server 1 outputs and records the contents of replies into the historical database 121 as a question history (Step S41).

Note that when there is no reply or answer from the user within a predetermined time period at Steps S33, S35, S37, S39, the way of speaking and the questions are changed, and then a process of Step S32 through S39 is again repeated as indicated by the broken line.

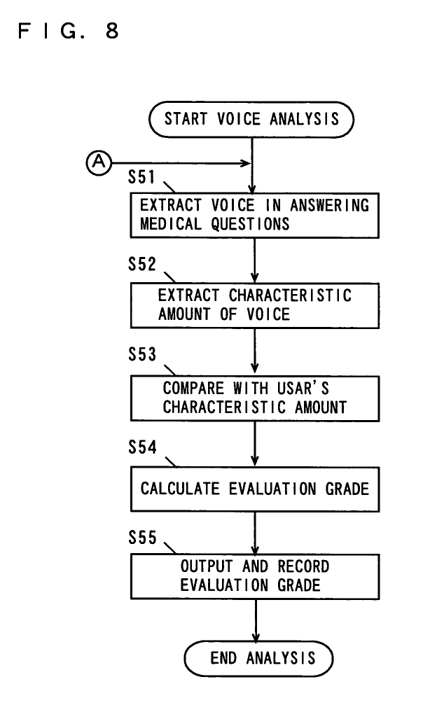

FIG. 8 is a flowchart showing a process of voice analysis by the operational unit 11 in the server 1.

The operational unit 11 in the server 1 initially instructs the user terminal 2 to extract the voice during answering of the questions (Step S51). This causes the operational unit 21 in the user terminal 2 to recognize by the voice recognition unit 29 the voice input to the voice input unit 27 from the microphone 42 while analyzing it by the voice analysis unit 29. The results of the voice analysis are transmitted to the server 1.

The operational unit 11 subsequently extracts a characteristic amount of the voice received from the user terminal 2 (Step S52). Then, the operational unit 11 compares the characteristic amount of the extracted voice with that of the user's usual voice stored in the voice characteristic database 124 (Step S53).

The operational unit 11 further calculates an evaluation grade based on the result of comparison (Step S54) to output and record the calculated evaluation grade as a voice analysis history in the historical database 121 (Step S55).

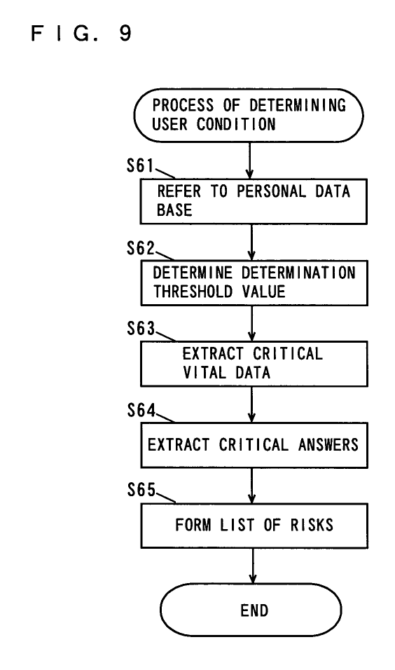

FIG. 9 is a flowchart showing a process of determination of a user condition by the operational unit 11 in the serve 1.

The operational unit 11 in the server 1 initially refers to the personal database 122 (Step S61). In this case, the operational unit 11 refers to the personal profile list and behavioral targets recorded in the personal database 122.

Then, the operational unit 11 determines a determination threshold value based on the personal profile list and behavioral targets recorded in the personal database 122 (Step S62). The determination threshold value here denotes a criterion value in determining whether each of the values of vital data (vital values) is normal. The determination threshold values include, for example, an upper limit of blood pressure, upper limit of body weight, and lower limit of the number of steps. The determination threshold values vary depending on the user. For an overweight individual, for example, the threshold value for the weight is set high at first, and gradually decreased.

The operational unit 11 subsequently extracts a critical vital data from the input vital data (Step S63). The critical vital data here denotes a vital data whose value exceeds the threshold value indicative of an upper limit or whose value is lower than the threshold value indicative of a lower limit.

Then, the operational unit 11 extracts a critical answer among the answers to the questions (Step S64). The critical answer here denotes a negative answer in terms of health among the answers to the lifestyle, mental, and physical questions. An answer of “Yes” in reply to a question, “Do you ever eat until you become full?” will, for example, be a critical answer.

Further, the operational unit 11 forms a list of risks based on the critical vital data and answers (Step S65). The list of risks here includes the critical vital data and time/date of the measurement along with the critical answers to questions and time/date of the measurement.

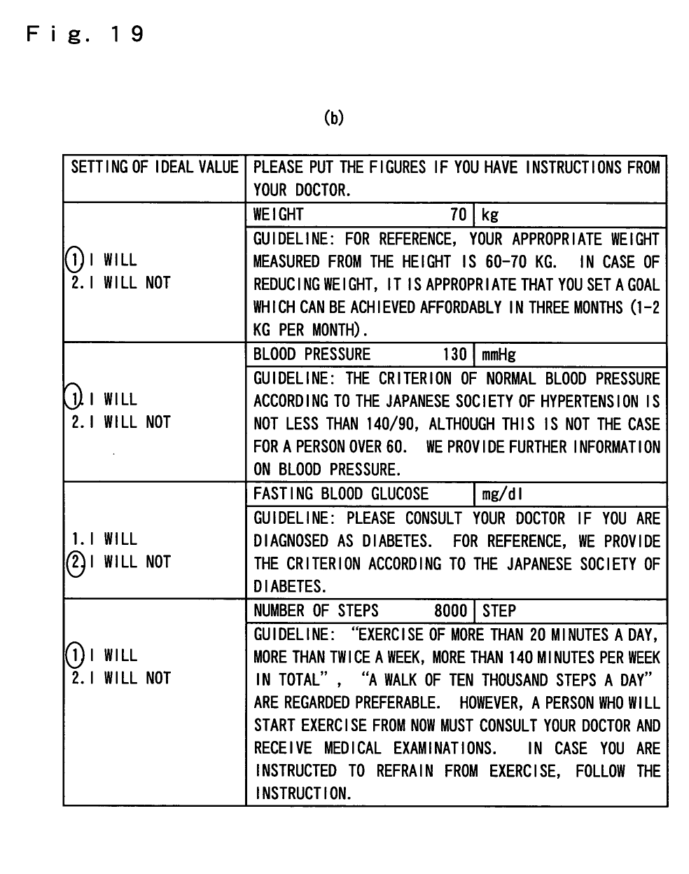

FIG. 20 shows one example of the list of risks. The list of risks is recorded in the personal database 122.

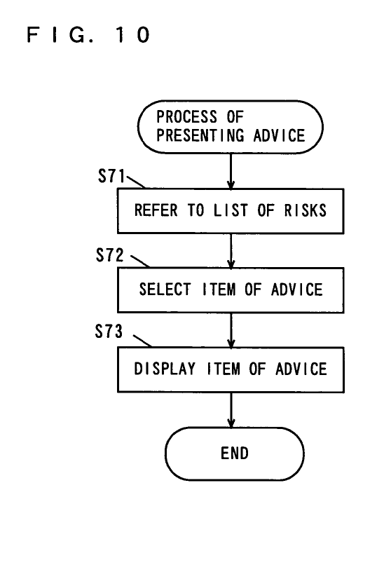

FIG. 10 is a flowchart showing a process of presenting advice by the operational unit 11 in the server 1.

Initially, the operational unit 11 in the server 1 refers to the list of risks recorded in the personal database 122 (Step S71).

The operational unit 11 subsequently selects appropriate advice items from the advice items recorded in the advice database 125 based on the list of risks (Step S72).

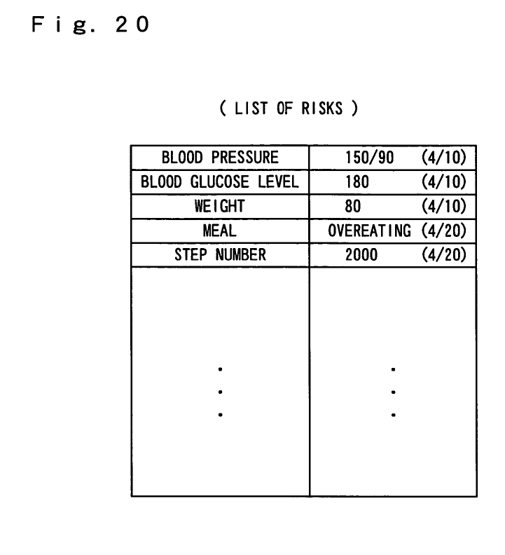

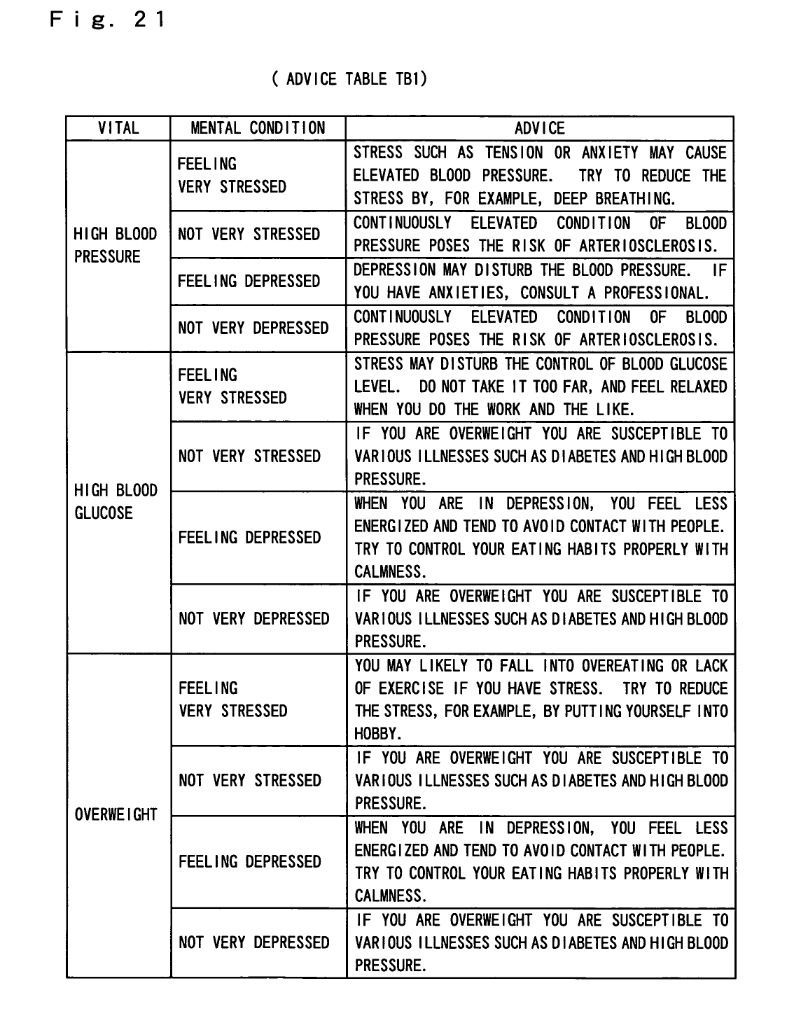

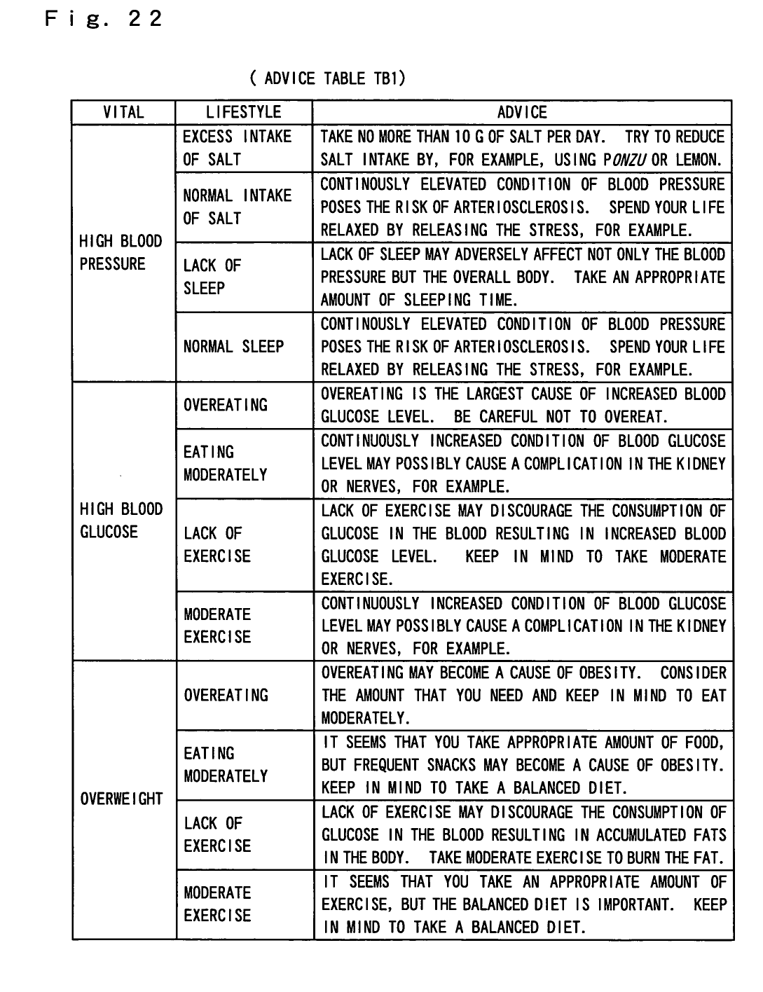

In this case, in the advice database 125, an advice table TB1 based on the vital data and mental condition, an advice table TB2 based on the vital data and lifestyle, and an advice table TB3 based on the vital data and physical condition are stored. The operational unit 11 selects advice items from the respective advice tables TB1, TB2, TB3 based on the list of risks. FIG. 21 shows one example of the advice table TB1; FIG. 22 shows one example of the advice table TB2; and FIG. 23 shows one example of the advice table TB3.

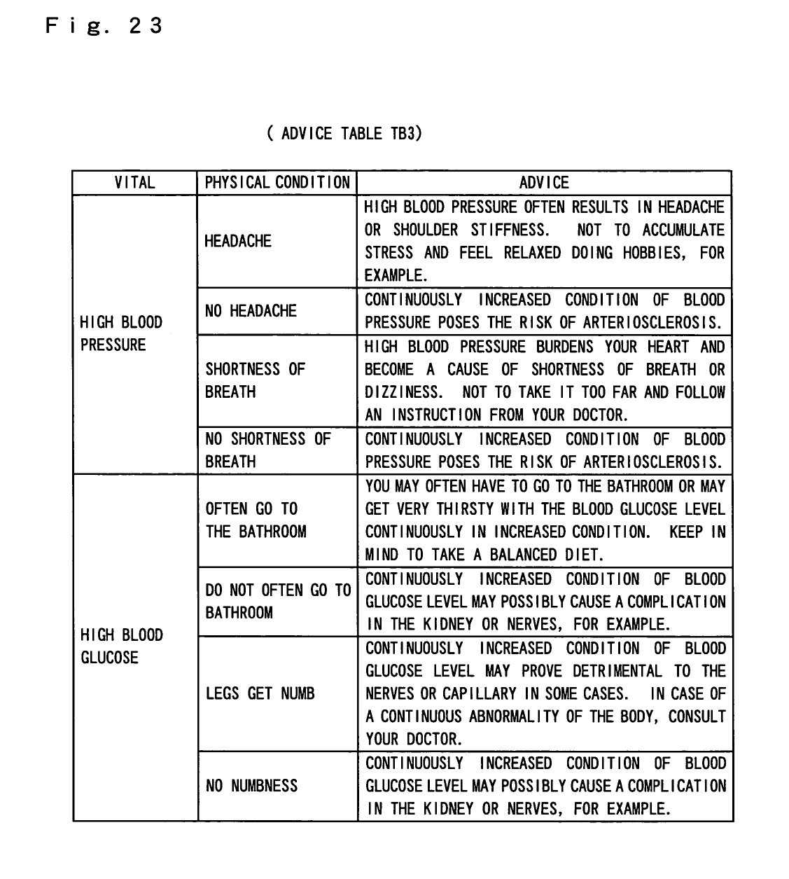

Then, the operational unit 11 displays the selected advice items on the user terminal 2 (Steps S73). FIG. 24 shows one example of such advice.

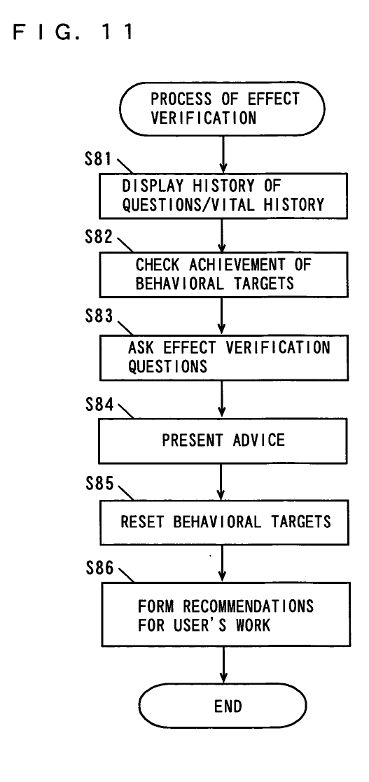

FIG. 11 is a flowchart showing a process of effect verification by the operational unit 1 in the server 1.

Initially, the operational unit 11 in the server 1 displays on the user terminal 2 the question history and vital history recorded in the historical database 121 (Step S81).

The operational unit 11 subsequently checks how the user has achieved the behavioral targets via the user terminal 2 based on the behavioral targets recorded in the personal database 122 (Step S82). In this case, the operational unit 11 displays a behavioral target checklist on the user terminal 2 requesting answers from the user. The user answers a degree of achievement for each behavioral target using the user terminal 2.

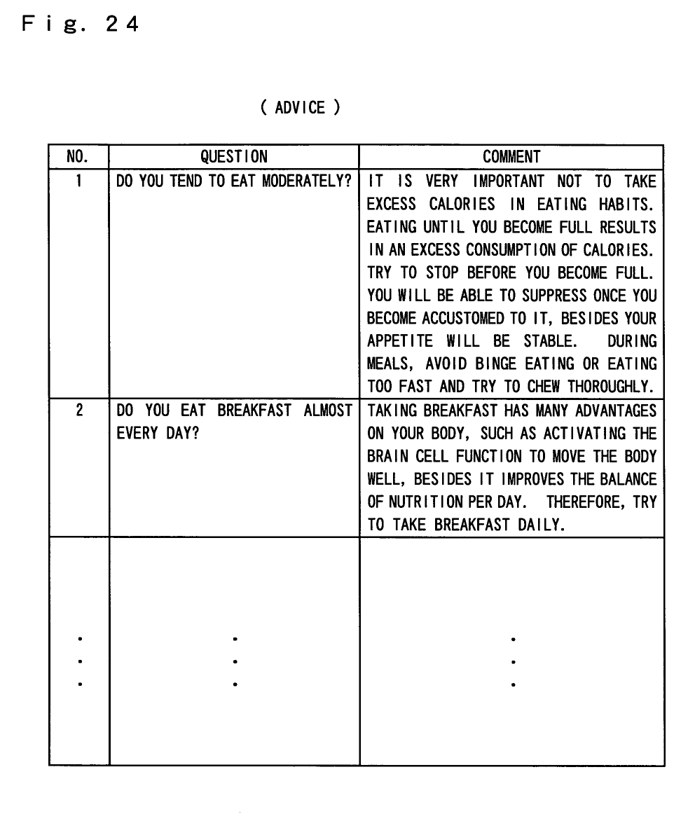

The answers from the user terminal 2 are transmitted to the server 1 from the user terminal 2. FIG. 25 shows one example of the behavioral target achievement checklist.

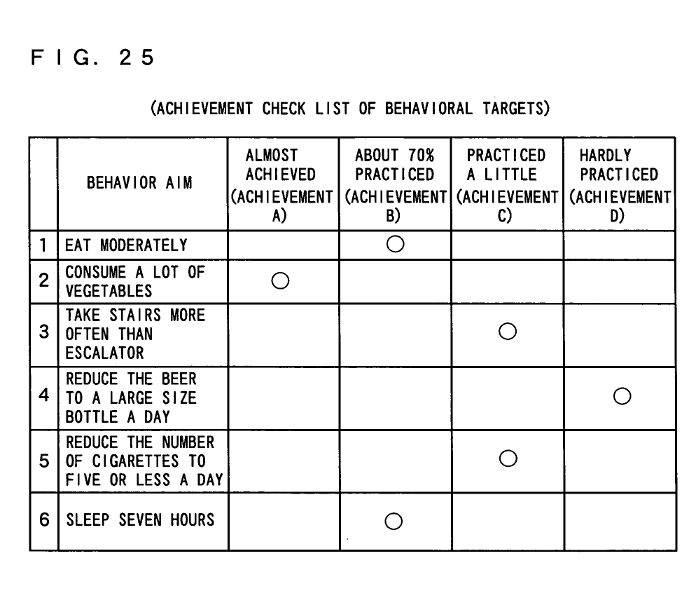

The operational unit 11 subsequently asks effect verification questions of the user via the user terminal 2 (Step S83). The effect verification questions here denote medical questions for verifying the effects of self-care based on the advice. FIG. 26 shows one example of the effect verification questions. The operational unit 11 displays or outputs as a voice the effect verification questions on the user terminal 2. The user inputs the answers to the effect verification questions via the user terminal 2. The input answers to the effect verification questions are transmitted to the server 1.

Then, the operational unit 11 presents advice to the user based on the answers to the behavioral target achievement checking and answers to the effect verification questions via the user terminal 2 (Step S84). Presentation of the advice will later be described in detail.

The operational unit 11 further instructs the user to reset the behavioral targets via the user terminal 2 (Step S85). In this case, the operational unit 22 forms recommended behavioral targets based on the answers to the behavioral target achievement checking and answers to the effect verification questions for display on the user terminal 2. Each item of the behavioral targets is provided with a preferential order. The user resets the behavioral targets for him/herself based on the recommended behavioral targets. The behavioral targets thus reset are transmitted to the server 1. The reset behavioral targets are recorded in the personal database 122. For example, among the behavioral targets shown in FIG. 19(a), the user resets the one saying “Reduce the beer to a large size bottle of beer” to “Reduce the beer to a medium size bottle of beer”. The user also resets the target value for the weight of “70 kg” to be “68 kg” among the target values shown in FIG. 19(b).

Finally, the operational unit 11 forms the recommendations for user's work based on the answers to the behavioral target achievement checking and answers to the effect verification questions (Step S86). For example, as for the recommendations for user's work of FIG. 18, the measurement times for the weight is modified from once a day to once per two days. The operational unit 11 displays the recommendations for user's work on the user terminal 2. The recommendations for user's work are recorded in the personal database 122.

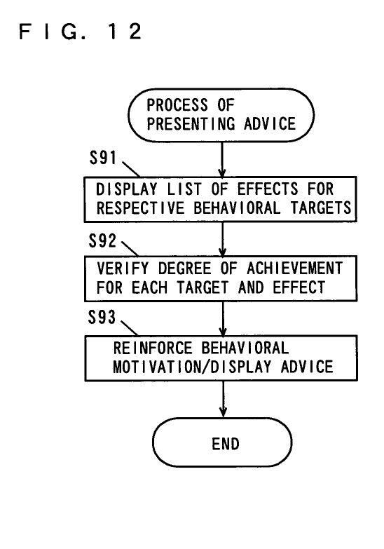

FIG. 12 is a flowchart showing a process of presenting advice by the operational unit 11 in the server 1.

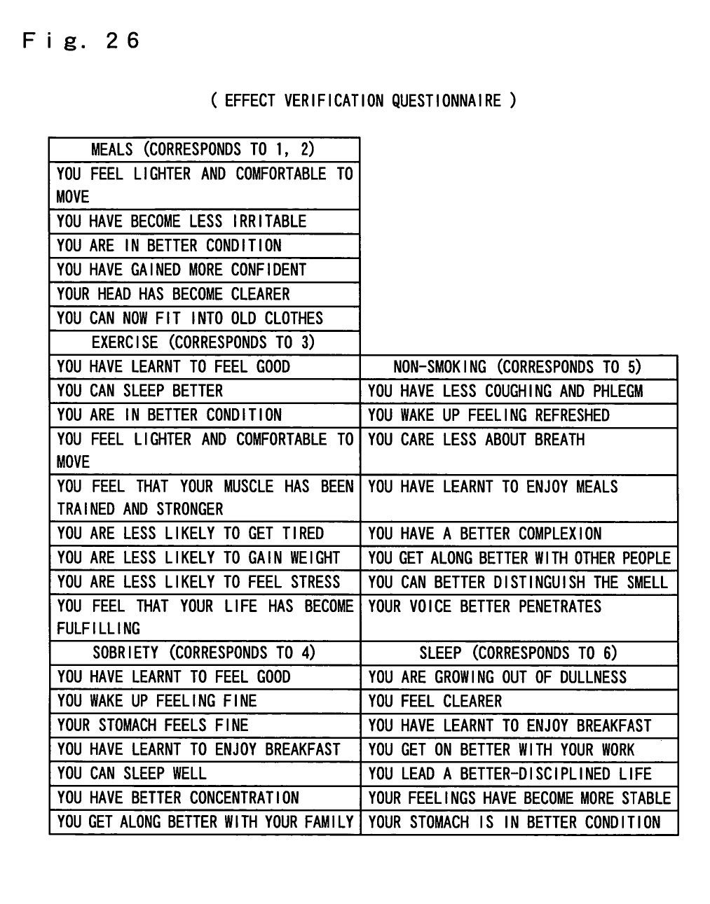

The operational unit 11 in the server 1 initially displays on the user terminal 2 a list of effects for the respective behavioral targets (Step S91). FIG. 27 shows one example of the list of effects.

The operational unit 11 subsequently performs verification of the degree of achievement for each target and its effect based on the answers to the behavioral target checking and answers to the effect verification questions (Step S92).

Then, the operational unit 11 displays on the user terminal 2 advice for reinforcing a behavioral motivation based on the result of the degree of achievement for each target and its effect (Step S93). Suppose, for example, that in the behavioral target achievement checking of FIG. 19, the behavioral target, “Reduce the number of cigarettes to five or less a day” is achieved with a grade C, and in the effect verification questions of FIG. 26, the question on the “non-smoking” list, “You have less coughing and phlegm” is answered in the affirmative. In this case, display of advice for reinforcing the behavioral target is provided, saying “Since you refrained from smoking, you have reduced coughing and phlegm, which is a good effect. If you keep it up, you will gain a better effect.”

Description is now provided of methods for changing the frequencies of measuring vital data and asking questions.

First, the method for changing the frequency of measuring vital data is described. In providing health care, the blood pressure of a patient with high blood pressure or the blood glucose level of a patient with diabetes is an item that must be measured for the patient, and accordingly, it is not appropriate to remove that from the items to be measured, as long as the patient has the disease. However, by changing the frequency of the measurement according to a change in his/her physical condition and the like, it is possible to determine the user condition effectively while enhancing user convenience.

The frequency of measurement of each item should be principally followed the instruction of a doctor; but, when a user without the need for consultation of the doctor conducts measurements for self health care, the user preferably starts the measurements with standard frequency, and then increase or decrease the frequency according to the condition.

When the measured values continue to be higher than a criterion value, the frequency is increased because of a possible increase of the risk and higher interests of the user himself, whereas the frequency is decreased when the measured values are lower than the criterion value, resulting in an appropriate frequency in view of both the health care and user's motivation.

As for an example of calculation expression for changing the frequency, the ratio of a measured value for each item to the criterion value is calculated, and the product of the ratio and the present frequency is calculated, with a calculation result being the frequency from next time. In this case, a lowest measurement frequency is set so that the frequency after changed may not lower the lowest measurement frequency.

Note, however, that for a user diagnosed as diabetes with the blood glucose level exceeding the criterion value, the frequency instructed by the doctor becomes the criterion. The user may be instructed to conduct measurements with the frequency instructed by the doctor. Alternatively, a measurement frequency setting table indicative of a relation between the present blood glucose level and the measurement frequency may be prepared to present a frequency according to the setting table, rather than changing the frequency based on the ratio of the measured value to the criterion value as mentioned above. The measurement frequency setting table is stored in the internal storage device 12 of FIG. 2.

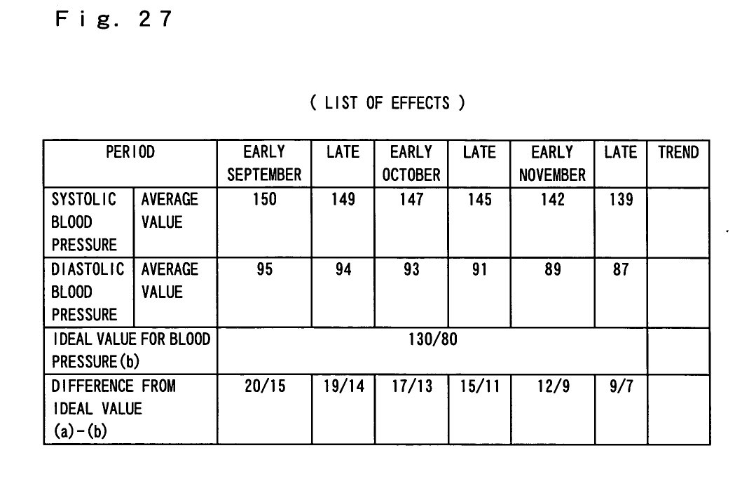

FIG. 28 is a flowchart showing a process of changing the frequency of measuring the vital data by the operational unit 11 in the server 1.

The operational unit 11 in the server 1 initially selects an item of input data (Step S101). The operational unit 11 subsequently determines whether a history of events-relating to the selected item of input data exists (Step S102).

Where there is no history of events relating to the item of input data, the operational unit 11 determines whether there is a measured value Vn of the vital data (Step S103). The measured value Vn here denotes a measured value for an item n of the vital data, n being an arbitrary integer.

Where the measured value Vn of the vital data exists, the measured value Vn of the vital data and a criterion value Sn are compared (Step S104) to determine whether the measured value Vn exceeds the criterion value Sn (Step S105). The criterion value Sn here denotes a criterion value for the item n of the vital data.

Where the measured value Vn exceeds the criterion value Sn, the operational unit 11 calculates a new frequency according to the following expression (Step S106):

Frequency=Fn×Vn/Sn

where Fn represents the present frequency of the item n of the vital data. In this case, the frequency increases.

Then, the operational unit 11 determines whether the calculated frequency exceeds a predetermined maximum frequency (Step S107). Where the calculated frequency does not exceed the maximum frequency, the operational unit 11 determines whether any other items of vital data exist (Step S108). Where other items exist, the operational unit 11 returns to Step S101, and where no other items exist, the process is completed.

At Step S102, where there is a history of events relating to the selected item of input data, the initial frequency is maintained (Step S109). The operational unit further determines whether any other items exist (Step S110). Where other items exist, the operational unit 11 returns to Step S101, and where no other items exist, the process is completed.

At Step S103, where there is no measured value Vn of the vital data, the operational unit advances to Step S110. At Step S105, where the measured value Vn does not exceed the criterion value Sn, the operational unit 11 determines whether the previously measured value is not more than the criterion value Sn (Step S111). Where the previously measured value is not more than the criterion value Sn, the operational unit 11 calculates a new frequency according to the following expression (Step S112):

Frequency=Fn×Vn/Sn

In this case, the frequency decreases. After that, the operational unit advances to Step S110. Where the previously measured value exceeds the criterion value Sn, it advances to Step S110.

At Step S107, where the calculated frequency exceeds a maximum frequency, the frequency is set to Fnmax (Step S113), then the operational unit 11 advances to Step S108. Here, the Fnmax denotes the maximum frequency.

In this way, the frequency of measuring the vital data is changed based on the measured value of the vital data.

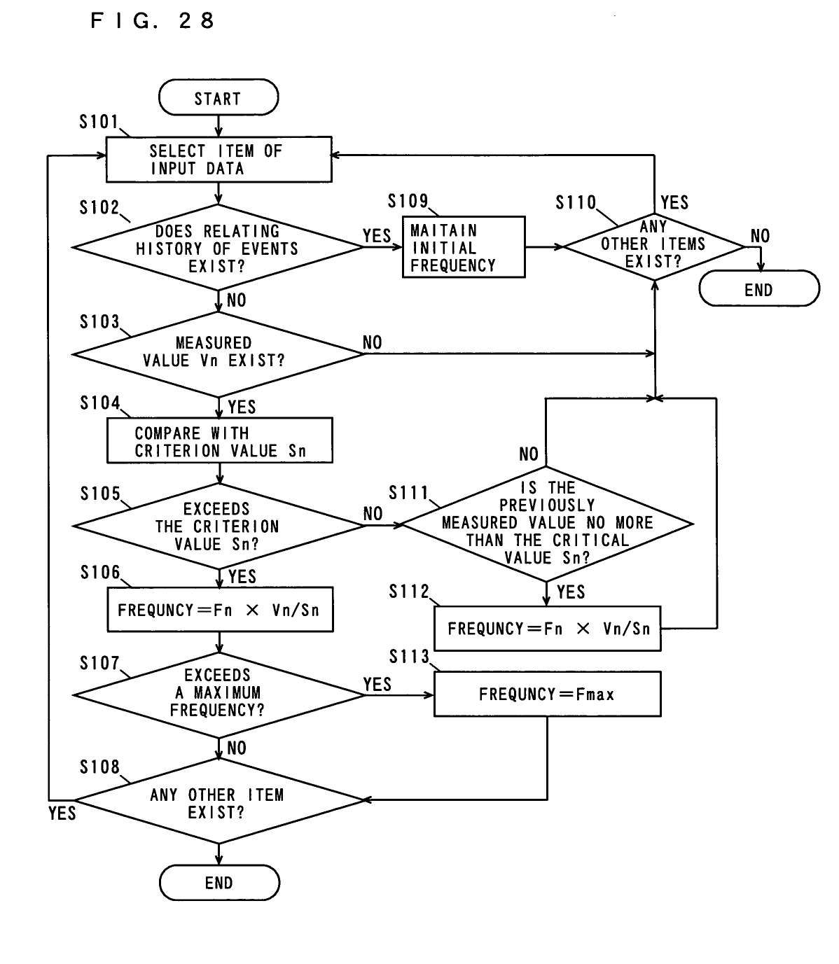

FIG. 29(a) shows one example of the measurement frequency setting table for the respective measured values of the vital data, and FIG. 29(b) shows a graph corresponding to the measurement frequency setting table of FIG. 29(a). According to the example of FIG. 29, the measurement frequency increases with an increase in fasting levels of plasma glucose concentrations.

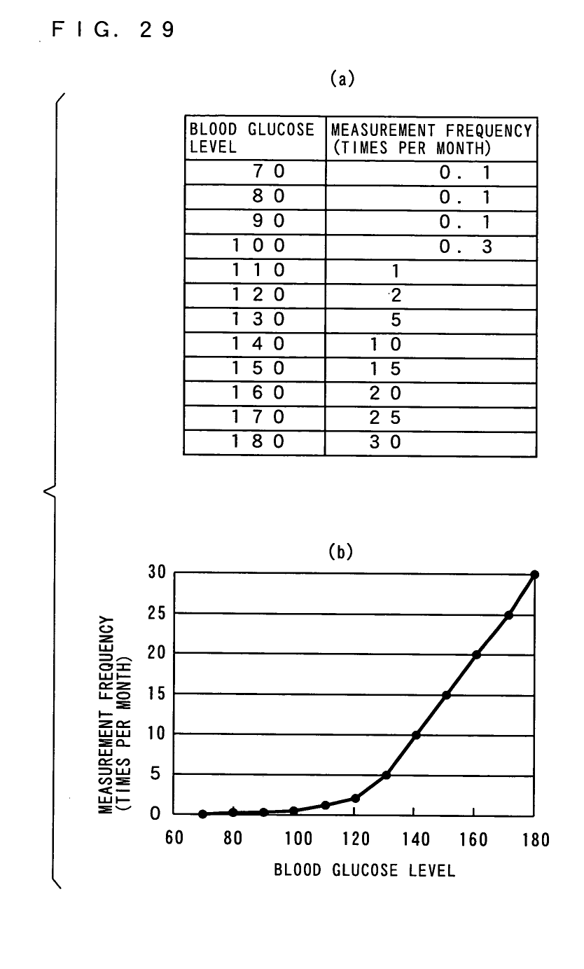

FIG. 30(a) shows another example of the measurement frequency setting table for the respective measured values of the vital data, and FIG. 30(b) shows a graph corresponding to the measurement frequency setting table of FIG. 30(a). According to the example of FIG. 30, the measurement frequency increases with an increase in the maximum blood pressure.

Description will subsequently be made of a method of changing the frequency of asking questions on lifestyle, physical condition, and mental condition.

Because there is no criterion value for the questions, a determination is made whether an obtained answer is critical. When the answer is not critical the frequency is decreased, whereas when the answer is critical, the frequency is increased. A method of increase/decreasing the frequency is to change the frequency by setting a coefficient of increase/decrease for each question, and multiplying the present frequency by the coefficient according to the answer of the user.

Note, however, that the initial state of the frequency should not be changed when there is a history of events relating to the question. In addition, the questions with answers which will not change after answered once, such as the weight at the age of 20 and experience of smoking, can be removed thereafter from the questions.

In this way, by increasing the frequency of asking important questions while decreasing the frequency of unimportant questions, it is possible to provide efficient and effective health care.

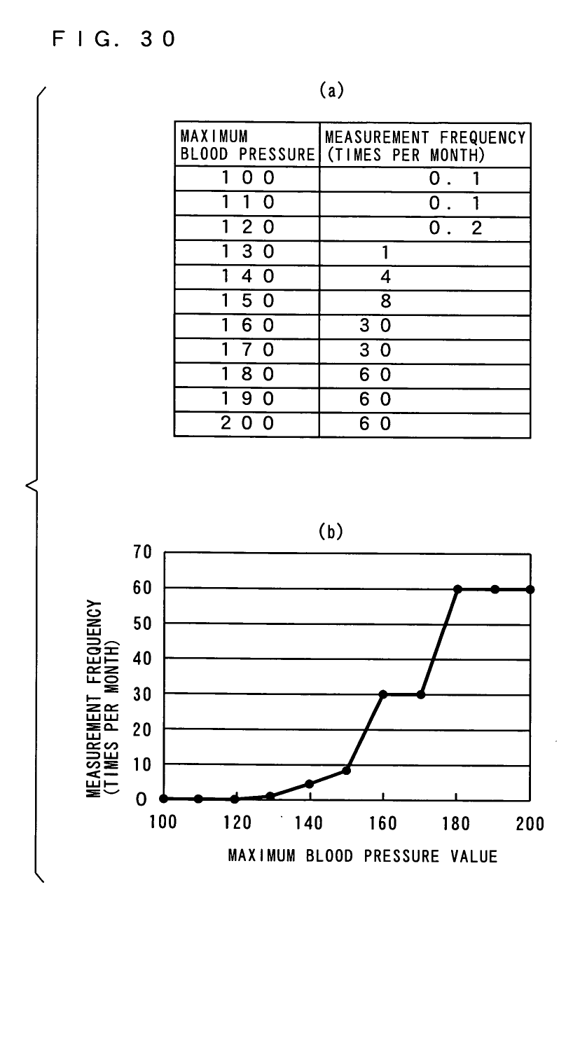

FIG. 31 is a flowchart showing a process of changing the frequency of asking a question by the operational unit 11 in the server 1.

The operational unit 11 in the server 1 initially selects a question to ask (Step S121). Then, the operational unit 11 determines whether a history of events exists relating to the selected question (Step S122).

Where such history of events do not exists, the operational unit 11 determines whether there is an answer (Step S123). Where there is an answer, the operational unit 11 determines whether the answer is critical (Step S124).

Where the answer is critical, the operational unit updates the frequency according to the following expression:

Frequency=Fn×βn

where Fn represents the present frequency of the item n, and βn represents an index of frequency increase with respect to the item n (1≦βn≦2). In this case, the frequency increases.

The operational unit 11 subsequently determines whether the calculated frequency exceeds a predetermined maximum frequency (Step S126). Where the calculated frequency do not exceed the maximum frequency, the operational unit 11 determines whether any other items exist (Step S127). Where other items exist, the operational unit returns to Step S121, and where no other items exist, the process is completed.

At Step S122, where a history of events relating to the selected question exists, the initial frequency is maintained (Step S128). The operational unit 11 further determines whether any other items exist (Step S129). Where other items exist, it returns to Step S121, and where no other items exist, the process is completed.

Where there is no answer at Step S123, the operational unit advances to Step S129. Where the answer is not critical at Step S124, the operational unit calculates a new frequency according to the following expression:

Frequency=Fn×αn

where an represents an index of frequency decrease (0≦αn≦1) with respect to the item. In this case, the frequency decreases.

Further, the operational unit 11 determines whether the calculated frequency is lower than a predetermined minimum frequency (Step S131). Where the calculated frequency is not less than the minimum frequency, the operational unit advances to Step 129. Where the calculated frequency is lower than the minimum frequency, the operational unit 11 determines whether the answer will not change (Step S132).

Where the answer will not change, the operational unit 11 removes the item (Step S133), and completes the process. Where the answer will change, the operational unit advances to Step S127.

At Step S126, where the calculated frequency exceeds the maximum frequency, the operational unit 11 sets the frequency to Fnmax (Step S134), and advances to Step S127. Here, the Fnmax denotes a maximum frequency.

In this way, the frequency of asking a question is changed based on the answer to the question.

Description will then be made of comprehensive determination of a condition based on the measured values of vital data, and answers to the lifestyle, physical, and mental questions.

In many typical health care systems, each of items of input data of the user is subject to analysis and judgment, and the results are presented in a row. Among a plurality of items of input data, however, there are some items relating to one another, such as weight-diet and blood pressure-stress.

In the embodiment, it is considered how each item on vital data, lifestyle, physical condition, and mental condition is related to another, and the health condition is determined by setting a related item table indicative of relations between items, with all the information obtained from a plurality of items being put together.

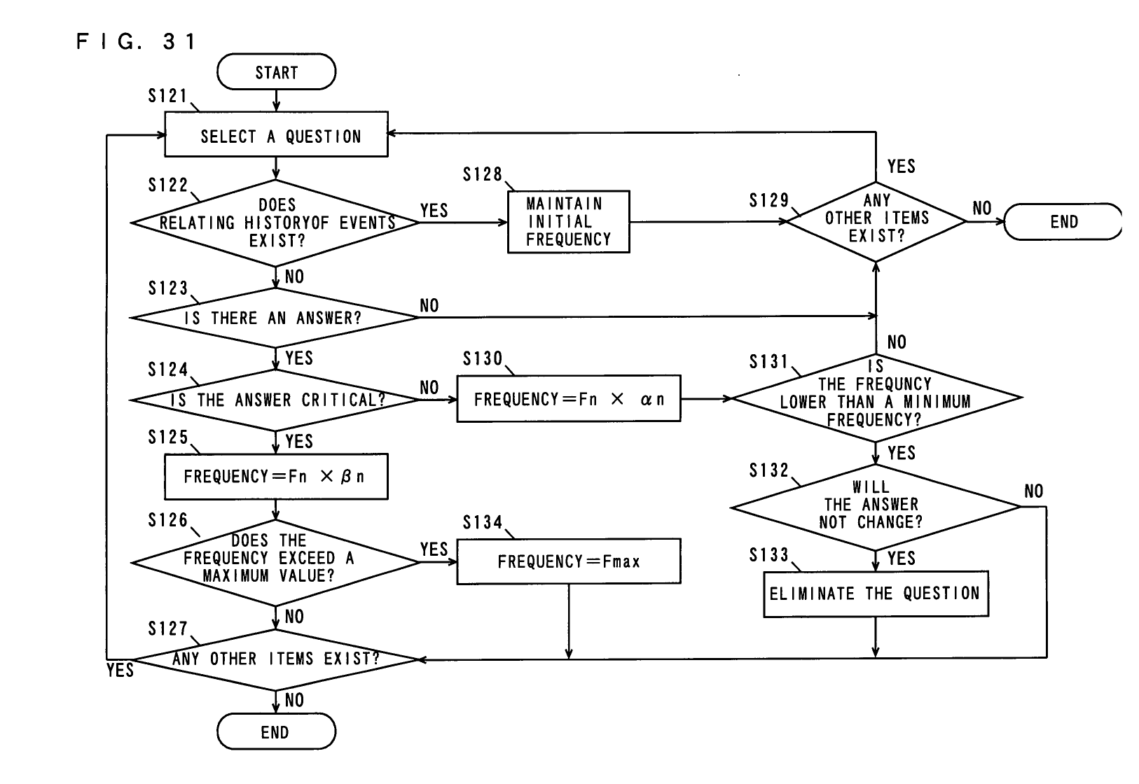

FIG. 32 shows one example of the related item table on lifestyle, physical condition, and mental condition. The related item table is stored in the internal storage device 12 of FIG. 2.

Initially, as shown in FIG. 32, each item is correlated with an item which may cause deterioration of the condition. For example, the item C of weight is related with the item D of stress, item F of diet, and item G of exercise. Some items exercise influence on each other, as with the item A of blood pressure and item D of stress.

For example, the result of determination of a risk is classified according to five levels (1: none, 2:almost none, 3:somewhat high, 4: high, 5: very high), and the items with the results of determination being “3” or higher are extracted as critical items.

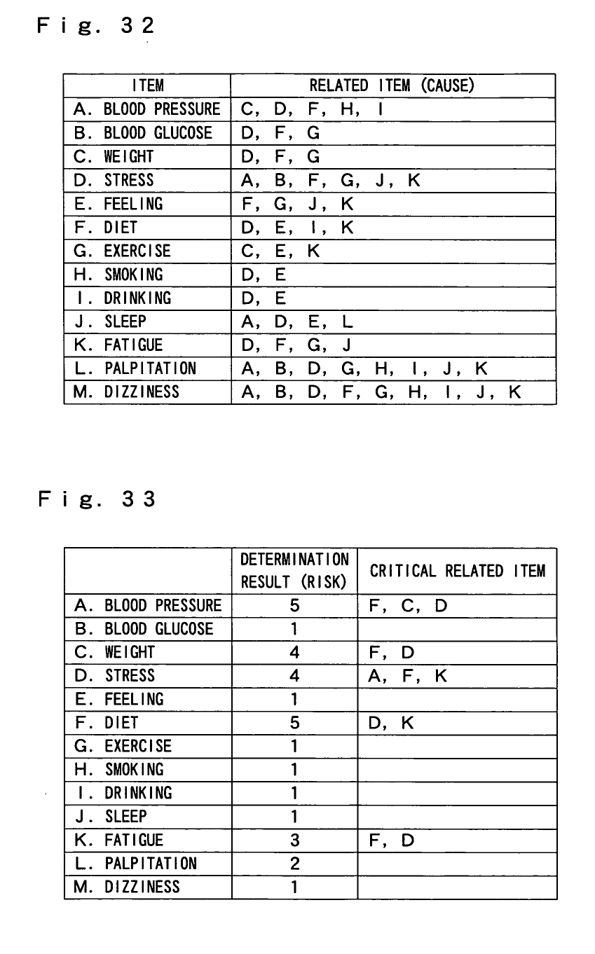

FIG. 33 shows one example of the result of determination of the risk for each item and the result of extraction of critical related items.

For example, the risk of item D relating to the item C is determined as “4”, the risk of item F is determined as “5”, and the risk of item G is determined as “1”. In this case, the items F, D are extracted as critical related items. In the example of FIG. 33, a determination is made that problems with blood pressure, weight, and fatigue have been developed due to the diet and stress.

General advice simply relating to “the weight” contains the meaning of, for example, “Try to take moderate exercise”. Such information is however unnecessary for a person who has been taking up exercise, and in some occasions may irritate the user. In addition, although such advice as “Try to eat moderately” is necessary, information on a specific approach falls short. Accordingly, the number of questions is increased from the next time so as to provide advice in more detail.

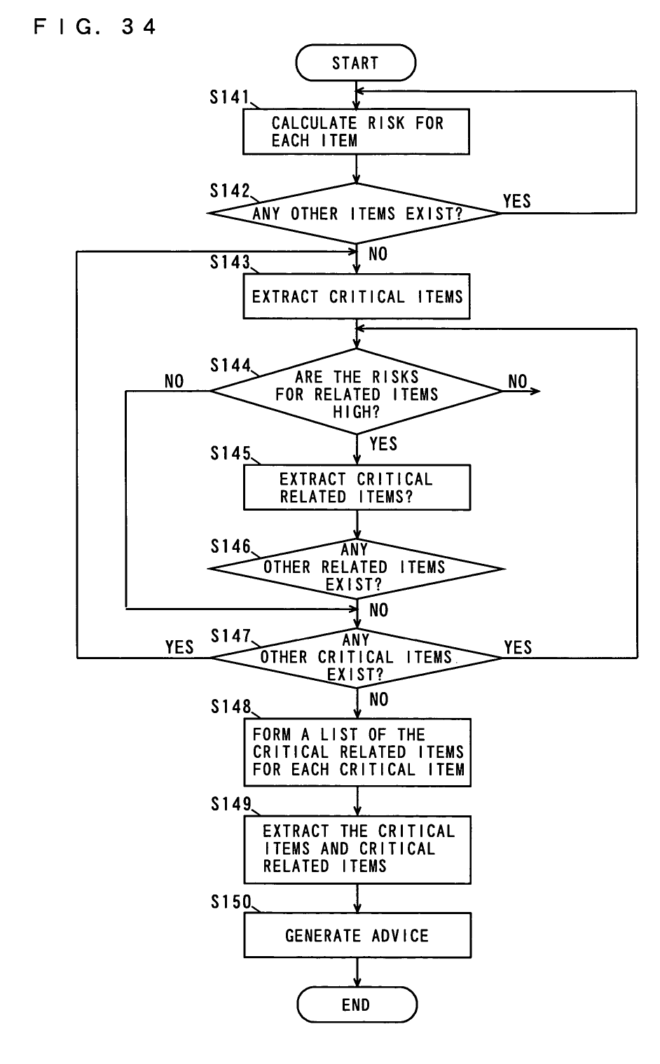

FIG. 34 is a flowchart showing a process of comprehensive determination of a condition by the operational unit 11 in the server 1.

The operational unit 11 in the server 1 initially calculates a risk for each item (Step S41). Then, the operational unit 11 determines whether any other items exist (Step S142). Where other items exist, a process of Step S141 is repeated. In the example of FIG. 33, results of determination of risks for the items A to M are obtained according to five levels.

Where no other items exist, critical related items are extracted based on the calculated risks (Step S143). In the example of FIG. 33, the item A with the determination result of risk higher than “3” is first extracted as a critical item.

The operational unit 11 subsequently determines whether the risks of related items for the extracted critical item are high (Step S144). In the example of FIG. 33, the related items for the item A are determined to be the items C, D, F, H, I according to the related item table of FIG. 32, and a determination is made if the risk of item C is not less than “3”.

Where the risk of the related item is high, the operational unit 11 determines the related item to be a critical related item, and extracts the critical related item (Step S145). In the example of FIG. 33, because the item C among the related items of the item A is not less than “3”, the item C is extracted as a critical related item.

At Step S144, where the risks of the related items are not high, the operational unit 11 advances to Step S146.

The operational unit 11 subsequently determines whether any other related items exist (Step S146). Where other related items exist, it returns to Step S144 for repetition of a process of Steps S144 to S146. This causes the related items F, C, D for the critical item A to be extracted as critical related items in the example of FIG. 33.

Where no other related items exist, the operational unit 11 determines whether any other critical items exist (Step S147).

Where other critical items exist, the operational unit returns to Step S143 for repetition of a process of Steps S143 to S147. This causes critical related items for the critical items A, C, D, F, K to be extracted in the example of FIG. 33.

Where no other critical items exist, the operational unit 11 forms a list of critical related items for each critical item (Step S148). In the example of FIG. 33, a list of critical related items for the critical items of A, C, D, F, K is formed.

After that, the operational unit 11 extracts the critical items and critical related items from the list (Step S149). Further, the operational unit 11 generates advice based on the extracted critical items and critical related items (Step S150).

In this way, comprehensive determination of a condition can be made based on the information obtained from the plurality of related items.

As discussed above, the health care support system according to the embodiment provides support for a patient with lifestyle-related disease to practice effective and efficient self health care through the optimization of the questions and optimization of the items of input data.

In addition, advice which is more fitted to an individual is presented, compared with the case where items of input data are in a single category. Furthermore, necessary items of input data according to the individual are provided at necessary timing, which is more effective than the case where input of a large amount of data is required for each of the wide-ranging items of input data.

As a result, it is possible to maintain a higher motivation, further facilitating the maintenance of self-care and achievement of targets.

In the embodiment, the operational unit 11 in the server 1 and the user terminal 2 correspond to acquisition units; the operational unit 11 corresponds to a determination unit and an extraction unit; and the operational unit 11 in the server 1 and the user terminal 2 correspond to presentation units. Also, the operational unit 11 in the server 1 and the user terminal 2 correspond to questioning units; and the operational unit 11 and the user terminal 2 correspond to input units. Further, the operational unit 11 in the server 1 corresponds to a judgment unit, a target formation unit, an evaluation unit, a changing unit, verification unit, and selection unit; and the user terminal 2 corresponds to a display.

Each of the acquisition unit, determination unit, extraction unit, presentation unit, questioning unit, input unit, judgment unit, target formation unit, evaluation unit, changing unit, verification unit, and selection unit may be composed of a CPU and a program, or composed of a hardware such as an electronic circuit.

While the health care support system is composed of the server 1 and the user terminal 2 in the embodiment, the user terminal 2 may have in part of all of the functions of the server 1 by installation of in part or all the health care support program into the user terminal 2. Where the user terminal 2 has the health care support program installed, the user terminal 2 functions as a health care support apparatus.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A health care support apparatus comprising:
an acquisition unit that acquires information relating to a health condition of a user; and
a changing unit that changes one or more items of information to be subsequently acquired by said acquisition unit and a frequency of acquisition, based on the information acquired by said acquisition unit.

2. The health care support apparatus according to claim 1, wherein
said changing unit compares the information acquired by said acquisition unit with a predetermined criterion value, and changes one or more items of information to be subsequently acquired by said acquisition unit and a frequency of acquisition, based on a result of the comparison.

3. The health care support apparatus according to claim 1, wherein
said changing unit stores beforehand a relationship between a value of information relating to a health condition of the user and a frequency of acquisition, and changes one or more items of information to be subsequently acquired by said acquisition unit and a frequency of acquisition, based on the information acquired by said acquisition unit and said relationship.

4. The health care support apparatus according to claim 1, wherein
said changing unit determines whether or not a contents of the information acquired by said acquisition unit is critical, and changes one or more items of information to be subsequently acquired by said acquisition unit and a frequency of acquisition, based on a result of the determination.

5. The health care support apparatus according to claim 1, further comprising:
a target formation unit that forms a behavioral or a health-related target of the user; and
an evaluation unit that evaluates a degree of achievement of the target formed by said target formation unit based on the information acquired by said acquisition unit.

6. A health care support apparatus comprising:
an acquisition unit that acquires information relating to a health condition of a user;
a determination unit that determines whether the information acquired by said acquisition unit is good or bad;
an extraction unit that extracts an item to be careful about the health condition of the user, based on a result of the determination of said determination unit; and
a presentation unit that presents advice relating to the item extracted by said extraction unit based on the information acquired by said acquisition unit.

7. The health care support apparatus according to claim 6, wherein
said acquisition unit acquires a plurality of items from a physiological data of the user, user's own information, information relating to a voice of the user, information relating to a physical condition of the user, information relating to a mental condition of the user, and information relating to a lifestyle of the user, and
said presentation unit presents advice based on a combination of the plurality of items of information acquired by said acquisition unit.

8. The health care support apparatus according to claim 7, wherein
said presentation unit extracts items of information relating to one another from the plurality of items of information acquired by said acquisition unit, and presents advice based on a combination of the extracted items of information.

9. The health care support apparatus according to claim 7, wherein
said presentation unit determines whether or not each item of the plurality of information acquired by said acquisition unit is critical, and extracts a critical item of information and a other critical item of information relating to said critical item of information, and presents advice based on a combination of the extracted items of information.

10. The health care support apparatus according to claim 6, further comprising a verification unit that verifies a user's behavior and an effect which relate to the health care, based on the information acquired by said acquisition unit, wherein
said presentation unit presents advice including a behavior to be conducted afterward based on a causal relationship between the behavior and the effect verified by said verification unit.

11. The health care support apparatus according to claim 6, further comprising:
a selection unit that selects an item to be improved relating to the behavior and health of the user based on the information acquired by said acquisition unit; and
a determination unit that determines a behavior for improving the item selected by said selection unit, wherein
said presentation unit presents advice including the behavior determined by said determination unit.

12. The health care support apparatus according to claim 6, further comprising a changing unit that changes one or more items of information to be subsequently acquired by said acquisition unit and a frequency of acquisition, based on the information acquired by said acquisition unit.

13. The health care support apparatus according to claim 6, wherein
said acquisition unit includes a questioning unit that asks questions to the user while inputting answers to the questions, wherein
said information relating to the health condition includes the answers input by said questioning unit.

14. The health care support apparatus according to claim 6, wherein
said questioning unit asks one or a plurality of questions from questions relating to physical condition, questions relating to mental condition, and questions relating to lifestyle, as a question to the user.

15. The health care support apparatus according to claim 6, wherein
said acquisition unit includes an input unit that inputs one or a plurality of items from information relating to a physiological data of the user, user's own information, and information relating to a voice of the user, wherein
said information relating to the health condition is input by the input unit.

16. The health care support apparatus according to claim 6, further comprising a display that displays a history of the information acquired by said acquisition unit or an item of information yet to be acquired by said acquisition unit.

17. A health care support system comprising:
a user terminal for use by a user; and
a host computer,
said host computer comprising:
an acquisition unit that acquires information relating to a health condition of the user from said user terminal; and
a changing unit that changes one or more items of information to be subsequently acquired by said acquisition unit and a frequency of acquisition, based on the information acquired by said acquisition unit.

18. A health care support system comprising:
a user terminal for use by a user; and
a host computer,
said host computer comprising:
an acquisition unit that acquires information relating to a health condition of the user from said user terminal;
a determination unit that determines whether the information acquired by said acquisition unit is good or bad;
an extraction unit that extracts an item to be careful about the health condition of the user based on a result of the determination of said determination unit; and
a presentation unit that presents on said user terminal advice relating to the item extracted by said extraction unit based on the information acquired by said acquisition unit.

19. A health care support method comprising the steps of:
acquiring information relating to a health condition of a user; and
changing one or more items of information to be subsequently acquired and a frequency of acquisition, based on said acquired information.

20. A health care support method comprising the steps of:
acquiring information relating to a health condition of a user;
determining whether said acquired information is good or bad;
extracting an item to be careful about the condition of the user based on a result of said determination; and
presenting advice relating to said extracted item based on said acquired information.

21. A computer-readable health care support program which enables a computer to implement the processes of:
acquiring information relating to a health condition of a user; and
changing one or more items of information to be subsequently acquired and a frequency of acquisition, based on said acquired information.

22. A computer-readable health care support program which enables a computer to implement the processes of:
acquiring information relating to a health condition of a user;
determining whether said acquired information is good or bad;
extracting an item to be careful about the health condition of the user based on said acquired information; and
presenting advice relating to said extracted item based on said acquired information.
